(19) United States
(12) Patent Application Publication
(10) Pub. No.: US 2013/0282336 A1
(43) Pub. Date: Oct. 24, 2013

(54) Anomaly Sensing and Diagnosis Method, Anomaly Sensing and Diagnosis System, Anomaly Sensing and Diagnosis Program and Enterprise Asset Management and Infrastructure Asset Management System

(71) Applicants: Shunji Maeda, Yokohama (JP); Hisae Shibuya, Chigasaki (JP); Hiroyuki Magara, Yokohama (JP)

(72) Inventors: Shunji Maeda, Yokohama (JP); Hisae Shibuya, Chigasaki (JP); Hiroyuki Magara, Yokohama (JP)

(73) Assignee: Hitachi, Ltd., Tokyo (JP)

(21) Appl. No.: 13/976,147

(22) PCT Filed: Nov. 22, 2011
(86) PCT No.: PCT/JP2011/076963

§ 371 Date: Jun. 26, 2013

(30) Foreign Application Priority Data
Dec. 27, 2010 (JP) 2010-289851

(51) Int. Cl. G05B 23/02

(52) U.S. Cl. CPC G05B 23/02
USPC 702/184

(57) ABSTRACT

In order to provide a facility of a plant or the like with an anomaly detection/diagnosis method and an anomaly detection/diagnosis system which are capable of detecting an anomaly of the facility with a high degree of sensitivity at an early time, pieces of maintenance-history information composed of past examples such as a work history and information on replaced parts are associated in advance with each other by the appearance frequency (context) of a keyword and, on the basis of anomaly detection making use of signals output by a multi-dimensional sensor installed in the facility as an object, the detected anomaly is linked to the pieces of maintenance-history information which are associated with each other. Thus, at a point of time prediction is detected, it is possible to give a relationship with a countermeasure such as a replacement of a part, an adjustment or a restart.

### BACKGROUND

The present invention relates to an anomaly detection/diagnosis method, an anomaly detection/diagnosis system, an anomaly detection/diagnosis program and enterprise asset management infrastructure asset management system which are used for sensing and diagnosing an anomaly of a plant or a facility at an early time and relates to an enterprise/facility-asset management system.

Among other operations, a power company makes use of typically waste heat of a gas turbine in order to provide a region with hot water for heating the region and provide a plant with high-pressure or low-pressure vapor. A petroleum chemistry plant operates a gas turbine or the like to serve as a power-supply facility. In this way, a variety of plants and facilities each making use of a gas turbine or the like detect an anomaly thereof at an early time, diagnose a cause of the anomaly and take a countermeasure against the anomaly in order to suppress damage inflicted on the society to a minimum, which is of very much importance to the society.

The facilities used as described above are not limited to the gas turbine and a vapor turbine. That is to say, the facilities used as described above may also be a water wheel employed in a hydraulic power plant, a nuclear rector employed in a nuclear power plant, a wind mill employed in a wind power plant, an engine employed in an airplane or heavy equipment, a railway vehicle, railway tracks, an escalator, an elevator, medical equipment such as an MRI, a manufacturing and inspection apparatus for semiconductors and flat panel display units as well as other facilities of the equipment and part levels. There are many more facilities required for detecting an anomaly such as a deterioration of an embedded battery or the life of such a battery at an early time and diagnosing a cause of the anomaly. Recently, the detection of anomalies (that is, a variety of disease states) of a human body for the purpose of health preservation is also becoming more and more important. Such anomalies are detected by typically measuring and diagnosing brain waves.

Thus, documents such as U.S. Pat. No. 6,952,662 (patent document 1), U.S. Pat. No. 6,975,962 (patent document 2) and Stephan W. Wegerich, Nonparametric modeling of vibration signal features for equipment health monitoring, Aerospace Conference, 2003. Proceedings. 2003 IEEE, Volume 7, Issue, 2003 Pages: 3113-3121 (Non-patent Document 1) describe sensing of an anomaly generated mainly in an engine. In accordance with the documents, past data is stored in a database (DB). First of all, the degree of similarity between observed data and the past learned data is measured by adoption of an original method. Then, linear combination of data having high degrees of similarity is used to compute inferred values. Finally, the degree of discrepancy between the inferred values and the observed data is output. The U.S. Pat. No. 6,216,066 (Patent document 3) describes typical detection proposed by General Electric as detection based on k-means clustering to sense an anomaly.

In addition, non-patent document 2 and JP-2009-110066-A (patent document 4) describe a process of acquiring useful knowledge on maintenance. In accordance with the documents, a failure history and a work history are stored in a database which can be searched for such histories in order to acquire the knowledge.

### SUMMARY

In general, there is widely used a system for monitoring observed data and comparing the data with a threshold value set in advance in order to sense an anomaly. In this case, since the threshold value is set by paying attention to, among others, the measurement-object physical quantity of the observed data, the system can be said to be dependent on the design basis.

With this method, it is difficult to sense an anomaly not intended by the design so that such an anomaly may be overlooked. For example, the set threshold value can no longer be said to be proper due to, among others, the operating environment of the facility, a condition change caused by the lapse of operating years, an operating condition and an effect of a part replacement.

In accordance with the techniques based on anomaly knowledge as disclosed in patent documents 1 and 2, on the other hand, learned data is used as an object and linear combination of data having high degrees of similarity between observed data and the learned data is used to compute inferred values before the degree of discrepancy between the inferred values and the observed data is output. Thus, depending on the preparation of the learned data, it is possible to consider, among others, the operating environment of the facility, a condition change caused by the lapse of operating years, an operating condition and an effect of a part replacement.

In accordance with the techniques disclosed in patent documents 1 and 2, however, the data is handled as a snapshot and data changes with the lapse of time are not taken into consideration. In addition, it is necessary to separately explain why an anomaly is included in the observed data. In the detection of an anomaly in a feature space having a little physical meaning as is the case with the k-means clustering described in patent document 3, the explanation of an anomaly becomes even more difficult. If the explanation of an anomaly is difficult, the detection of the anomaly is treated as incorrect detection.

In addition, in accordance with the method described in patent document 4, there is constructed a system in which a failure history and a work history are stored in a database which can be searched for such histories in order to acquire useful knowledge on maintenance. In accordance with patent document 4, there is constructed a system for displaying maintenance medical charts. In this system, information on a failure history and a work history can be bonded to each other through a search operation so that the information can be presented in a visible form.

However, the bonding of the anomaly detection and the maintenance history information is not clear so that it is hard to say that the maintenance information stored in the system can be used effectively. With only a simple search function, even the bonding of the failure history and the work history themselves is not always successful. In such maintenance information, various kinds of information are generally dispersed and, in addition, there are many enumerations of ambiguous words so that the bonding is impossible unless a keyword serving as a keystone of the search operation is devised carefully. That is to say, in a method depending on only a search operation, from the detected anomaly including a predicted anomaly, it is impossible to clarify, among others, a portion of the past information to be inspected in order to determine the cause of the anomaly, the handling carried out in the past for the cause of the anomaly and what should be done this time for the cause of the anomaly. Thus, even if the cause of the anomaly is diagnosed immediately at the anomaly detection stage, the phenomenon, the cause of the anomaly, the part to be replaced and the like remain unclear so that it is impossible to determine what action should be done. As a result, in the reality of the condition, inspection carried out in the field by a skilled maintenance person is relied on.

It is thus an object of the present invention to present an anomaly detection/diagnosis method and an anomaly detection/diagnosis system which are capable of accurately diagnosing a newly generated anomaly (including a predicted anomaly) by making use of maintenance history information comprising past examples such as anomaly detection information and work-history/replaced-part information which take sensing data as an object.

In addition, it is another object of the present invention to present a diagnosis program which can be presented by a beginner.

On the top of that, it is a further object of the present invention to present an enterprise/facility-asset management system making use of the anomaly detection/diagnosis method and the anomaly detection/diagnosis system.

In order to achieve the objects described above, in accordance with the present invention, pieces of maintenance-history information comprising past examples as is the case with anomaly detection information and work-history/replaced-part information are associated with each other in advance by frequencies of appearances of keywords. Then, on the basis of anomaly detection taking signals output by a multi-dimensional sensor added to a facility as an object, the detected anomaly and the associated maintenance history information are combined with each other so that, at a point of time the predicted anomaly is detected, it is possible to provide relationships with countermeasures such as part replacements, adjustments and resumption. In this way, the diagnosis and the handling which are to be carried out for the generated anomaly can be clarified. In addition, work commands can be implemented.

In particular, to express a condition (referred to hereafter as a context) in which maintenance-history information is used, the frequency of appearance of a keyword is handled by being regarded as a context pattern. That is to say, including anomaly detection, from main keywords representing typically works related to maintenance, a context taking the actually used condition into consideration is acquired as a frequency pattern to be described later and a context-oriented anomaly diagnosis activating the context is expressed.

To put it concretely, in the anomaly detection, the following operations are carried out:

(1): (All but) normal learned data is generated.
(2): The anomaly measure of observed data is computed by adoption of a subspace method or the like.
(3): The anomaly is determined.
(4): The type of the anomaly is identified
(5): The time of generation of the anomaly is estimated and pieces of maintenance-history information are associated with each other
(6): A keyword of a set of documents describing maintenance-history information and the like is extracted
(7): Images are classified
(8): The keywords are associated
(9): A diagnosis model is generated to serve as a model expressing the association of the anomaly with the keyword as a frequency pattern
(10): The diagnosis model is used for classifying the anomaly detected in the plant or the facility or classifying a predicted anomaly so as to clarify a diagnosis and/or handling which are to be carried out

In addition, in order to achieve the objects described above, in accordance with an anomaly detection/diagnosis method provided by the present invention to serve as a method for detecting an anomaly generated or predicted at a plant or a facility at an early time and diagnosing the plant and the facility, an anomaly generated in the plant or the facility is detected by handling data acquired from a plurality of sensors as an object, a keyword is extracted from maintenance-history information of the plant or the facility, a diagnosis model of the plant or the facility is generated by making use of the extracted keyword and the anomaly detected or predicted at the plant or the facility is diagnosed by making use of the generated diagnosis model.

In addition, the maintenance-history information includes ones of on-call data, work reports, the codes of adjusted/replaced parts, image information and audio information. The frequency of appearance of a keyword determined from the maintenance-history information is computed in order to obtain a pattern of the appearance frequency. The obtained appearance frequency pattern is used as a diagnosis model. The similarity between the appearance frequency pattern and a keyword for an anomaly newly detected in a plant or a facility is used in order to carry out a diagnosis on the anomaly detected or predicted in the plant or the facility.

In addition, in order to achieve the objects described above, an anomaly detection/diagnosis system provided by the present invention to serve as a system for detecting an anomaly generated or predicted at a plant or a facility at an early time and diagnosing the plant and the facility is configured to comprise:

an anomaly detection section for detecting an anomaly of the plant or the facility by handling data obtained from a plurality of sensors as an object;

a database section used for storing maintenance-history information of the plant or the facility;

a diagnosis-model generation section for generating a diagnosis model of the plant or the facility by making use of a keyword extracted from the maintenance-history information stored in the database section as the maintenance-history information of the plant or the facility; and

a diagnosis section for carrying out a diagnosis on an anomaly newly detected or predicted in the plant or the facility by collating the detected or predicted anomaly with the diagnosis model.

In addition, the maintenance-history information stored in the database section includes ones of on-call data, work reports, the codes of adjusted/replaced parts, image information and audio information. The diagnosis-model generation section computes the frequency of appearance of a keyword determined from the maintenance-history information in order to obtain a pattern of the appearance frequency. The diagnosis-model generation section makes use of the appearance frequency pattern as a diagnosis model. The diagnosis section makes use of similarity of the appearance frequency pattern for a newly detected anomaly in order to carry out a diagnosis on the facility.

On the top of that, in order to achieve the objects described above, an anomaly detection/diagnosis program provided by the present invention to serve as a program for detecting an anomaly generated or predicted at a plant or a facility at an early time and diagnosing the anomaly is configured to comprise:

a processing step of detecting the anomaly by handling data obtained from a plurality of sensors as an object;

a processing step of generating a diagnosis model by making use of the frequency of appearance of a keyword acquired from maintenance-history information; and

a diagnosis processing step of carrying out a diagnosis on an anomaly detected or predicted in the plant or the facility by making use of the diagnosis model generated at the processing step of generating a diagnosis model.

As described above, at the processing step of detecting an anomaly, the anomaly is detected by handling data obtained from a plurality of sensors as an object. At the processing step of generating a diagnosis model, a diagnosis model is generated by making use of the frequency of appearance of a keyword acquired from maintenance-history information. At the diagnosis processing step, in a diagnosis carried out on the facility by making use of the generated diagnosis model, a pattern or a keyword is extracted through detection of anomaly and/or a diagnosis of a phenomenon. The extracted pattern or the extracted keyword is used in a diagnosis.

In addition, in order to achieve the objects described above, an enterprise/facility-asset management system according to the present invention is configured to comprise:

a database used for storing maintenance-history information including work reports and information on replaced parts;

detection means for detecting a generated anomaly or a predicted anomaly by making use of signal information obtained from a multi-dimensional sensor added to a facility and making use of identification means such as a subspace technique; and

diagnosis means for carrying out a diagnosis on the basis of a frequency pattern of a keyword paying attention to replacement parts, adjustments and the like.

In addition, the enterprise/facility-asset management system is configured to also implement detection of a predicted anomaly and a diagnosis taking the detection of a predicted anomaly as a trigger.

In accordance with the present invention, it is possible to arrange a lot of maintenance-history information existing in the field by making use of relations with anomalies. For a generated anomaly or a predicted anomaly, it is also possible to speedily determine handling of the anomaly at a standpoint of a necessary countermeasure, a necessary adjustment or the like. In addition, a proper instruction can be given to a person in charge of maintenance works. Since a condition in which the maintenance-history information is used can be accurately expressed as a context pattern and since it can be collated with, the stored maintenance-history information can be reused.

In accordance with them, early and accurate detection of an anomaly as well as a diagnosis and handling which have to be carried out become clear not only for facilities such as a gas turbine and a vapor turbine, but also for a water wheel employed in a hydraulic power plant, a nuclear rector employed in a nuclear power plant, a wind mill employed in a wind power plant, an engine employed in an airplane or heavy equipment, a railway vehicle, railway tracks, an escalator, an elevator and those at the facility and part levels. Anomalies detected at the facility and part levels include anomalies of a variety of facilities and parts. Examples of such anomalies are a deterioration of an embedded battery or the life of such a battery. It is needless to say that the present invention can also be applied to measurements and diagnoses of human bodies.

### BRIEF DESCRIPTION OF THE DRAWINGS

FIG. 1 is a block diagram showing typical facilities each serving as an object of an anomaly detection system according to the present invention, typical multi-dimensional time-series signals and typical event signals;

FIG. 2 is graphs representing signal waveforms of the typical multi-dimensional time-series signals;

FIG. 3A is a block diagram showing an example of detailed information on a maintenance history;

FIG. 3B is a block diagram showing an example of relations between a phenomenon, a cause and handling;

FIG. 4A shows an exemplary embodiment of the present invention and a typical flow of processing in which pieces of maintenance-history information comprising past examples and work-history/replacement-part information are associated with each other in advance by a keyword base and, then, on the basis of anomaly detection taking signals output by a multi-dimensional sensor added to a facility as an object, an anomaly is detected and the detected anomaly and the associated maintenance history information are combined with each other;

FIG. 4B is a graph showing a frequency pattern of a failure phenomenon causing a valve to be replaced;

FIG. 4C is a block diagram showing a process of classifying detected predictions in accordance with phenomena and/or countermeasures at a learning time;

FIG. 4D is a block diagram showing a process of classifying detected predictions in accordance with phenomena and/or countermeasures at an operation time;

FIG. 4E is a joint histogram acquired to serve as graphs representing countermeasures taken against anomaly phenomena in a decreasing-frequency order starting with a countermeasure having the highest frequency;

FIG. 5 is a typical table showing data for alarm generations, field inspections and handling descriptions which include a reset operation, an adjustment, a part replacement and a takeout inspection;

FIG. 6 is a typical table showing units, part numbers and part names;

FIG. 7A is a table associating phenomena with adjusted/replaced parts and showing frequencies on the basis of bonding;

FIG. 7B is a table associating phenomena with adjusted/replaced parts and showing frequencies on the basis of bonding;

FIG. 8 shows a diagnosis procedure referred to as a diagnosis fault tree;

FIG. 9 shows another example of the diagnosis procedure referred to as the diagnosis fault tree;

FIG. 10 shows an actual diagnosis procedure based on a diagnosis fault tree;

FIG. 11 is a block diagram showing the configuration of an anomaly detection system provided by the present invention;

FIG. 12 is an explanatory block diagram to be referred to in description of an example-based anomaly detection technique making use of a plurality of identification means;

FIG. 13A is an explanatory diagram to be referred to in description of a projection distance technique which is a kind of a subspace technique serving as an example of the identification means;

FIG. 13B is an explanatory diagram to be referred to in description of a local subspace technique which is a kind of the subspace technique serving as an example of the identification means;

FIG. 13C is an explanatory diagram to be referred to in description of a mutual subspace technique which is a kind of the subspace technique serving as an example of the identification means;

FIG. 14A is an explanatory diagram to be referred to in description of selection of learned data in the subspace technique;

FIG. 14B is a graph showing a frequency distribution of distances between learned data seen from observed data;

FIG. 15 is an explanatory table showing a variety of characteristic transformations;

FIG. 16 is a diagram showing a 3-dimensional space to be referred to in explanation of a locus of a residual-error vector computed in the subspace method;

FIG. 17 is a block diagram showing the configuration of a processor periphery for executing the present invention;

FIG. 18A is a block diagram showing a configuration for detecting an anomaly by driving a processor to process sensor signals and carrying out characteristic-extraction/classification on time-series signals;

FIG. 18B is a block diagram showing the configuration of an anomaly prediction/diagnosis system 100;

FIG. 19 is a diagram showing network relations between sensor signals; and

FIG. 20 is a flow diagram showing details of maintenance-history information and associations of the maintenance-history information.

### DESCRIPTION OF THE PREFERRED EMBODIMENTS

The present invention relates to an anomaly detection/diagnosis system for detecting an anomaly generated or predicted in a plant or a facility an early time. In a process of detecting an anomaly, all but normal learned data is generated and the anomaly measure of observed data is computed by adoption of the subspace method or the like. Then, an anomaly is determined and the type of the anomaly is identified. Subsequently, the time at which the anomaly has been generated is estimated.

In addition, in a process of associating pieces of maintenance-history information with each other, a keyword of a set of documents describing the maintenance-history information and the like is extracted and the keyword is associated with the anomaly through image classification or the like.

Then, a diagnosis model expressing the association of the keyword with the anomaly as a frequency pattern is generated. The diagnosis model is used for clarifying a diagnosis and handling which are to be carried out for the detected or predicted anomaly.

The following description explains an exemplary embodiment of the present invention by referring to diagrams.

### Exemplary Embodiment

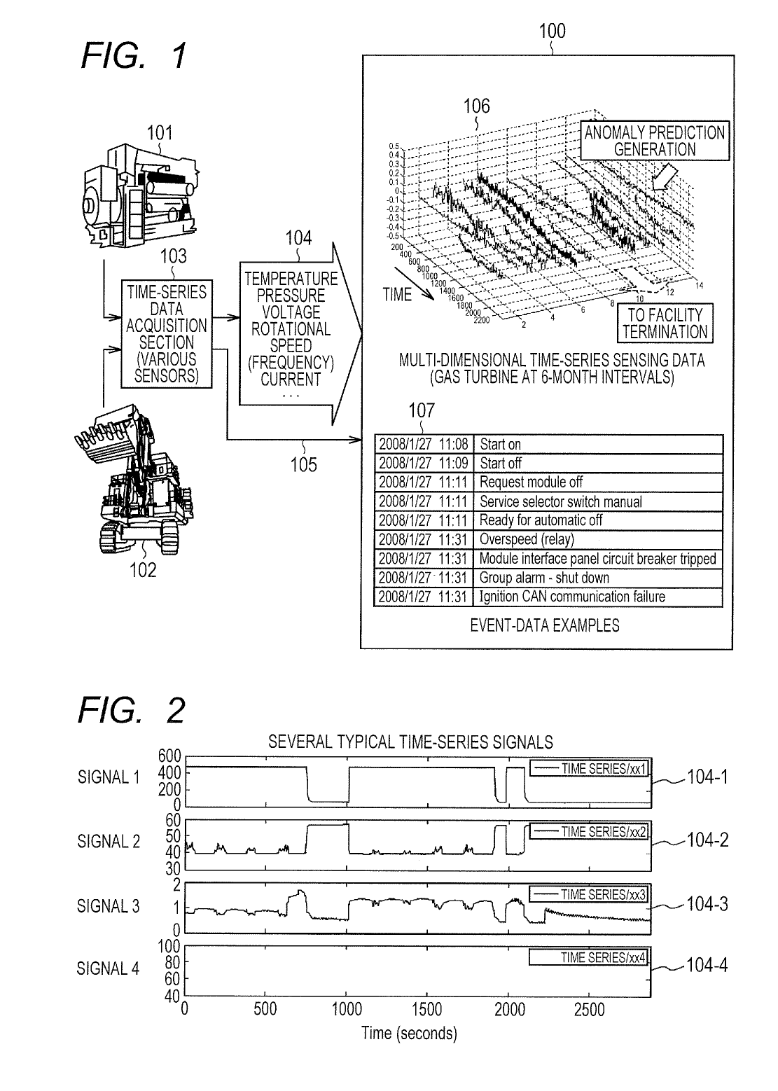

FIG. 1 shows an entire configuration including an anomaly prediction/diagnosis system 100 according to the present invention. In the figure, reference numerals 101 and 102 each denote a facility serving as an object of the anomaly prediction/diagnosis system 100 according to the present invention. The facilities 101 and 102 are provided with a multi-dimensional time-series signal acquisition section 103 configured to include a variety of sensors. The multi-dimensional time-series signal acquisition section 103 acquires sensor signals 104 as well as event signals 105 serving as alarm signals and signals indicating the on/off status of power supplies. The sensor signals 104 and the event signals 105 are supplied from the multi-dimensional time-series signal acquisition section 103 to the anomaly prediction/diagnosis system 100 according to the present invention. The anomaly prediction/diagnosis system 100 processes the sensor signals 104 and the event signals 105. The anomaly prediction/diagnosis system 100 according to the present invention acquires multi-dimensional time-series data 106 and event signals 107 from the sensor signals 104 received from the multi-dimensional time-series signal acquisition section 103, processing the multi-dimensional time-series data 106 and the event signals 107 in order to carry out anomaly detection/diagnosis processing on the facilities 101 and 102. The number of types of the sensor signal 104 acquired by the multi-dimensional time-series signal acquisition section 103 is a number in a range of several tens to several hundreds of thousands. Depending on factors such as the sizes of the facilities 101 and 102 as well as damage which are inflicted on society when either of the facilities 101 and 102 fails, a variety of costs are taken into consideration in order to determine the types of the sensor signal 104 acquired by the multi-dimensional time-series signal acquisition section 103.

The object handled by the anomaly prediction/diagnosis system 100 is the multi-dimensional time-series sensor signals 104 acquired by the multi-dimensional time-series signal acquisition section 103. The sensor signals 104 include signals representing a generator voltage, an exhausted-gas temperature, a cooling-water temperature, a cooling-water pressure and an operating-time length. The installation environment or the like is also monitored. The interval of timings to sample the sensors is a time period in a range of about several tens of ms to about several tens of seconds. That is to say, there is a variety of such intervals. The sensor signals 104 and the event data 105 include the operating states of the facilities 101 and 102, information on a failure and information on maintenance. FIG. 2 shows sensor signals 104-1 to 104-4 appearing along the time axis serving as the horizontal axis of the figure.

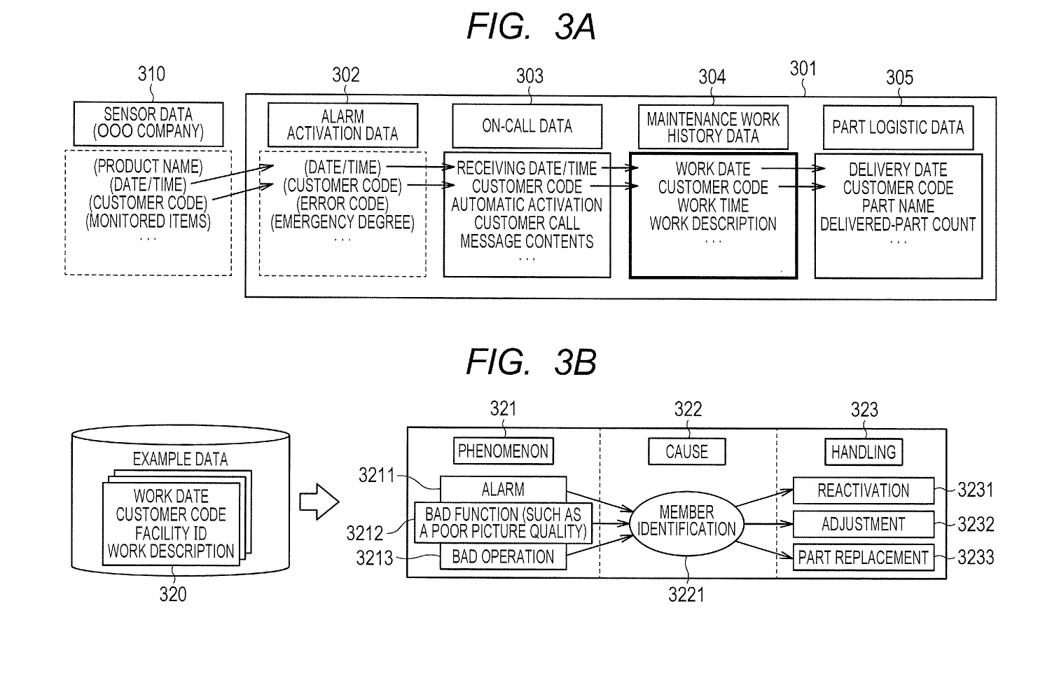

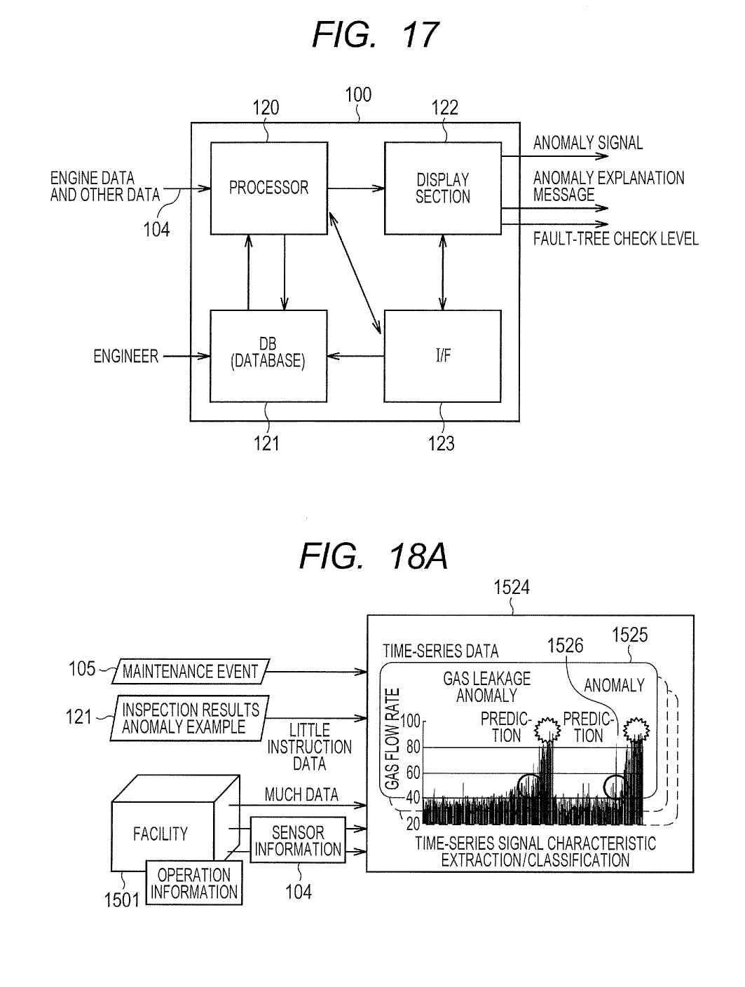

FIG. 3A shows details 301 of maintenance-history information of the anomaly prediction/diagnosis system 100. As shown in the figure, when sensor data 310 is received, alarm activation information 302, on-call data 303, maintenance work history data 304 and part logistics data 305 are associated with the maintenance-history information. The on-call data 303 shown in FIG. 3A means telephone contact data. These pieces of information are stored in a database (DB) which is denoted by reference numeral 121 in FIG. 17.

Arrows shown in FIG. 3A indicate that the pieces of information are linked from the upstream side to the downstream side. These arrows can also be oriented from the downstream side. In this case, the means that can be adopted is referred to as a search operation based on a keyword. The search operation is effective means. However, it is necessary to construct the data to be searched into the structure of a database (DB), that can be searched, in advance. In addition, some devices are required in determination of a keyword. Flexibilities are also required to absorb vertical relations of members and vertical relations of phenomena. Since the search operation is simple collation, however, this means can be adopted with ease.

FIG. 3B is a diagram showing associations of the maintenance-history information. The figure shows keywords of works such as a phenomenon 321, a cause 322 and handling 323 which are to be searched from example data 320 stored in the database (DB) denoted by reference numeral 121 in FIG. 17. The phenomenon 321 is further classified into detailed categories including alarms 3211, bad functions (such as poor picture qualities) 3212 and bad operations 3213. The cause 322 corresponds to failing-member identification 3221. The handling 323 comprises an item 3231 representing an anomaly that can be eliminated by restarting (even though the anomaly is not completely corrected), an item 3232 representing an anomaly requiring adjustment and an item 3233 representing an anomaly requiring replacement of a part. FIG. 3B also makes use of arrows to indicate relations.

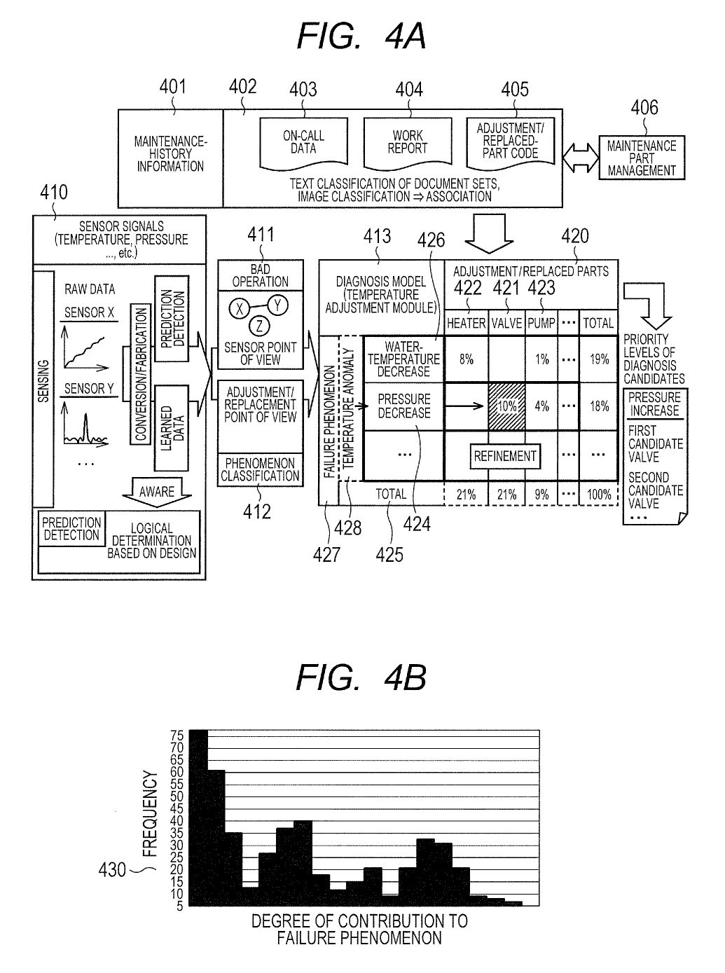

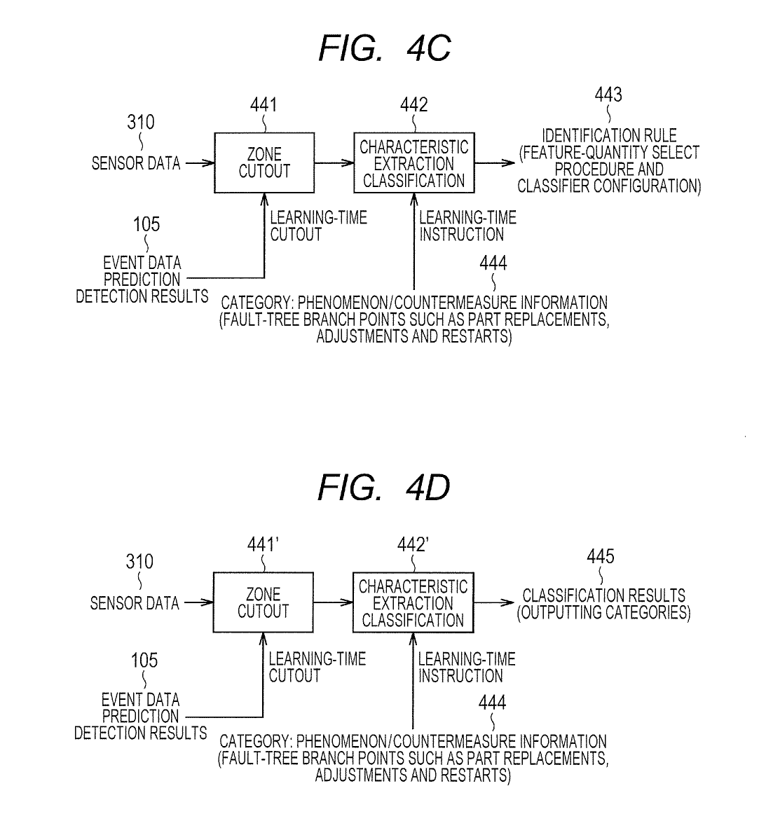

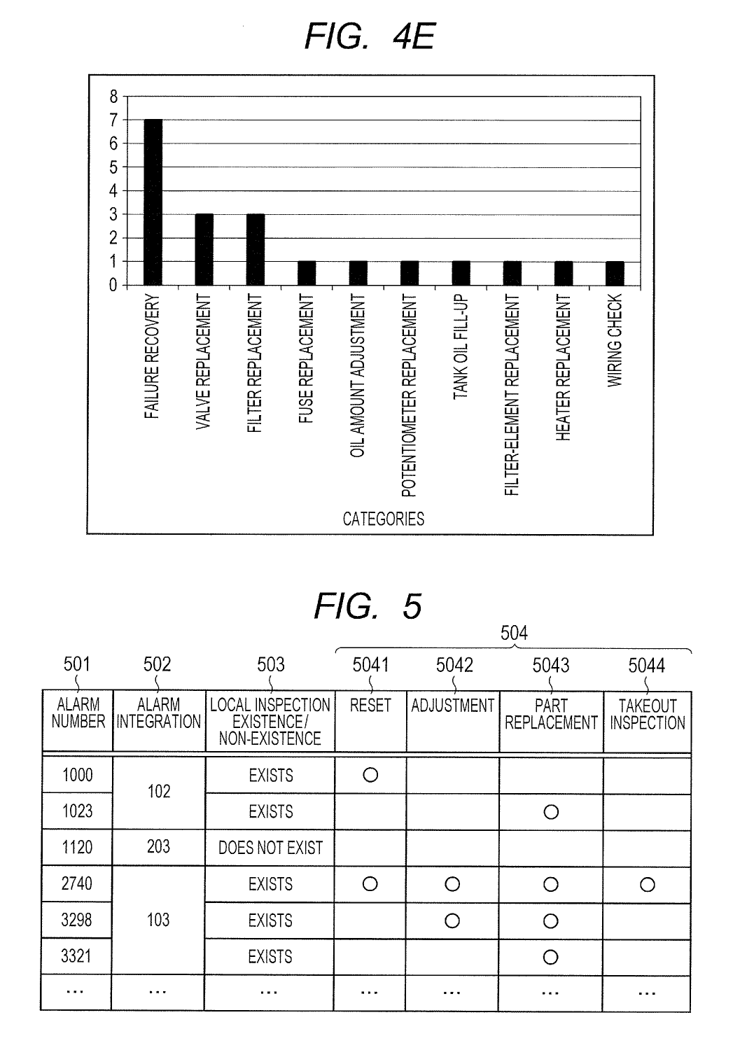

FIGS. 4A to 4E show an exemplary embodiment of the anomaly prediction/diagnosis system 100 according to the present invention. To be more specific, FIG. 4A shows an example in which pieces of maintenance-history information comprising past examples as is the case with anomaly detection information and work-history/replacement-part information are associated with each other in advance by a keyword base and, then, on the basis of anomaly detection taking signals output by a multi-dimensional sensor added to a facility as an object, an anomaly is detected and the detected anomaly and the associated maintenance history information are combined with each other. To express the stored condition (context) which maintenance-history information is used, the frequency of appearance of a keyword is handled by being regarded as a context pattern in this embodiment.

In this exemplary embodiment, the concept of a bag of words is adopted. The concept of a bag of words is a technique which should also be referred to as a bag of characteristics. In accordance with this concept, information (characteristics) is handled by ignoring the generation order of the information and its positional relations. In this technique, from alarm activation information, work reports, the codes of replacement parts and the like, the frequencies of generations of keywords, codes and words as well as a histogram are created. The distribution form of this histogram is regarded as a characteristic for classification into categories. This method is characterized in that, unlike the one-to-one search like the one described in non-patent document 2, a plurality of pieces of information can be handled at the same time. In addition, this method can also be used to handle free descriptions so that this method can also be used with ease to handle changes such as additions and deletions of information. On the top of that, this method is also effective for changing the format of a work report or the like. Even if a plurality of dispositions are carried out or even if an incorrect disposition is included, since attention is paid to the distribution form of the histogram, the robustness is high. In the same way, sensor signals are also classified into a plurality of categories. These categories are keywords.

Such an expression represents a condition in which maintenance has been carried out and is also referred to as a context. A context gives responses to questions including those described as follows:

In what condition was its information effective?

For what purpose was it used?

Why was it used?

What is attention paid to?

What are relations with other information?

The context is represented by the keyword appearance frequency pattern described above.

Concrete explanation referring to FIG. 4A is given as follows. An example of replacement of a part is explained. In FIG. 4A, from the inside of the maintenance-history information 401 (corresponding to the example data 320 shown in FIG. 3B), a replacement-part record 405 (corresponding to the part replacement 3233 shown in FIG. 3B) is automatically accessed. For example, an example of replacement of a valve is given. Information including a part name (the name of the replaced valve), a part number (the code of the replaced valve) and a replacement date is used as a keyword. As periphery information of the maintenance-history information, a part table or the like has been usually prepared in advance. Thus, this part table is accessed and a keyword is added to serve as a keyword for information including the name of a unit to which the replacement part pertains. Next, a work report 404 for this part replacement is accessed. This report describes how the part has been replaced. Information including the name of the alarm, the name of the phenomenon, items to be confirmed and adjusted portions is added as a keyword. The items to be confirmed and the adjusted portions have been described in the handling contents (reactivation, adjustment and replacement of the part).

The name of an alarm is information generated in remote monitoring of a facility. In FIG. 4A, the name of an alarm is information pertaining to sensor signals 410 shown on the left side. The name of an alarm is the name of an anomaly which can be a decrease of the water pressure, an increase of a pressure, an extremely high rotational speed, an abnormal noise, a poor picture quality or the like. The name of an alarm is expressed by a code such as a number. If a diagnosis of a phenomenon is carried out on the remote monitoring side, a phenomenon diagnosis result implemented by reference numeral 411 is also added as a keyword. In this case, the phenomenon diagnosis result indicates whether or not there is a correlation between monitored sensor signals and indicates a phase relation between them. These are converted into a keyword or quantized to produce the phenomenon diagnosis result. The object can be an anomaly at a prediction stage instead of a generated anomaly.

As shown in FIG. 4A, a plurality of keywords described above, that is, a code book, is summarized into a histogram with a table format 420. In the example of replacement of a valve, within the table, on a column of the replaced valve 421, the frequency of appearance increases. On a total row 425 at the bottom of the table format 420, valves 421 occupy 21%. If a heater 422 and a pump 423, which are parts other than the valves 421, are also replaced, their appearance frequencies also increase. In addition, as a phenomenon diagnosis 411, a pressure decrease has been reported. Thus, in the table 420, the frequency of an intersection (a hatched portion in the table 420) of the valve 421 and the pressure decrease 424 increases.

In FIG. 4A, data is normalized and expressed in terms of percentages (%) in place of frequencies. However, it can also be expressed in terms of frequencies. If the examples of replacement of valves of the same type are summarized, a more reliable table can be generated. In this way, a diagnosis table reflecting past examples can be created. In the bag-of-words method, this frequency pattern is taken as a feature quantity. The frequency pattern of the column for valves represents frequencies for a plurality of phenomena leading ahead of the replacement of a valve.

It is to be noted that a keyword and a code book are given by the designer and a person in charge of maintenance, being stored in the maintenance-history information 401. However, weights may also be added to them by the importance. By making use of a mutual time relation between keywords as a relation showing a short or long period of time, a weight may be added or used as a selection reference.

Next, the following description explains a case in which an anomaly has been newly generated. In the phenomenon diagnosis 411, the type of an anomaly is determined by the sensor-signal point of view. For example, the name of the anomaly is determined to be a pressure decrease. In this case, in accordance with the diagnosis model described above, the probability of the replacement of a valve is 10%. Since this probability is known to be higher than other cases, in order to confirm that this valve is to be replaced, first of all, the diagnosis model is used in the field. It is needless to say that the sensor signals may also be analyzed in more detail in order to identify the failing member.

In this exemplary embodiment, the table 420 is further utilized. Normally, the phenomenon is complicated so that, even if the name of the anomaly is determined to be a pressure decrease, there are also conceivably many cases in which a part other than a valve is replaced. Thus, attention is paid to a frequency pattern representing a failure phenomenon 427. In the table 420 shown in FIG. 4A, the frequency pattern is the frequencies 430 of a water-temperature decrease 426 or a pressure decrease 424. For every phenomenon, as shown in FIG. 4B, a frequency pattern 430 of a failure phenomenon leading ahead of the replacement of a valve is generated. The vertical axis represents the frequency whereas the horizontal axis represents the type of the failure phenomenon and the degree of contribution to the failure phenomenon. This frequency pattern 430 is taken as a feature quantity and, as a frequency pattern matching this feature, the frequency pattern of a valve, that is, the valve 421, is selected. In the example shown in FIG. 4B, the horizontal axis takes the failure phenomenon leading ahead of the replacement of a valve. However, the details of the countermeasure, things to be confirmed, places to be adjusted or others can be taken as items of the horizontal axis. It is to be noted that the degree of contribution to the failure phenomenon is the degree of separation from normal states of the sensor signals (denoted by reference numeral 104 in FIG. 2).

Thus, it is necessary to pay attention to the fact that, with regard to data to be observed and diagnosed, the diagnosis start time is a kind of pattern instead of a frequency. It is needless to say that, at the diagnosis start time, information can be used to serve as not only the contribution degree, but also the frequency of the contribution degree which is a time-axis summary.

Attention is paid to time-series variations of a residual vector shown in FIG. 16 to be described later. If the variations are handled as a generation frequency in a fixed time window, the variations can be handled frequency information or a frequency pattern. In either case, in the method based on the frequency pattern described above, attention is paid to the distribution form instead of carrying out simple processing of existence or non-existence. Thus, in comparison with a technique based on a simple search operation, the flexibility and the robustness are extremely high.

As described above, if a diagnosis model is adopted, the diagnosis work can be carried out smoothly in the field so that the time it takes to carry out the diagnosis work can be shortened substantially. In addition, a candidate for a part to be replaced can be prepared in advance so that the recovery time of the facility can also be shortened considerably as well.

In the example described above, a frequency pattern is taken as the type of a failure phenomenon. However, any information other than a frequency pattern can be used as long as the information is usable. Examples of the usable information are a confirmed member, an adjusted member, information acquired from an on-call, a replacement part and an explained takeout anomaly cause. It is also a reason for which the bag-of-words method paying attention to the frequency can be used. In addition, when there are many items of the horizontal axis, the number of dimensions can also be said to be large. Thus, reducing the number of dimensions in advance is effective. The ordinary pattern recognition technique can also be said to be usable. Examples of the ordinary pattern recognition technique are an analysis of principal components, an analysis of independent components and selection of a feature quantity. It is also possible to adopt a normalization technique such as the whitening technique.

In the anomaly detection/analysis system shown in FIG. 4A, as a classification point of view, an example of a replacement part is shown. However, there may be another classification point of view. A category of another definition can be created on the horizontal axis as a table (a diagnosis model) 420. An example of the category is an adjusted member such as a setting dial including a numerical value, a verified item of the condition, a resistance and a set time. That is to say, in accordance with the objective, the condition and the user, a plurality of diagnosis models separated from each other on a plurality of sheets are adopted. It is to be noted that a pattern statistic method other than the bag-of-words method can also be adopted.

This diagnosis model can also be adopted as educational information for young scholars. In addition, by adopting the diagnosis model as a base, it can be reflected in a maintenance work procedure.

In FIG. 4A, the phenomenon classification 412 is also important. In this case, the phenomenon classification is defining a keyword (a category) in advance for an anomaly detected with sensor signals 410 taken as an object at a view point of handling such as adjustment and/or replacement. The defined keyword (category) is added or corrected and used in the diagnosis model 413. To put it concretely, in accordance with a result of the phenomenon classification, the keyword (the category) is added to the generated anomaly or a predicted anomaly. If a water-pressure increase has been detected, addition of ‘water-pressure increase’ as a keyword (a category) is a simplest case. In addition, in accordance with classification based on a determination tree such as C4.5, a keyword (a category) can be added automatically. A keyword is added in accordance with the phenomenon, and at the stage of clarifying the type of the adjustment and the type of the replacement, keywords (categories) are grouped or segmentalized in order to add a new keyword (category). The capability of editing the phenomenon classification in this way is necessary.

The maintenance-history information 401 shown in FIG. 4A should also be referred to as an EAM for maintenance. In general, the EAM is an abbreviation of the enterprise asset management which is also called the enterprise/facility-asset management. In the management, various kinds of information on facility assets owned by an enterprise are managed uniformly throughout their life cycles in order to find a job improvement solution for visualizing, standardizing and efficiency improving the assets themselves and jobs related to the assets. However, the management in FIG. 4A is the EAM specialized for maintenance. In such maintenance EAM, in addition to written-document management such as the maintenance-history information 401, predicted anomaly detection, diagnosis and maintenance part planning are included. It is to be noted that the maintenance part planning is proper calculation for inventory management of maintenance parts used for implementing maintenance on the basis of a diagnosis result.

FIGS. 4C and 4D are block diagrams showing operations to create a recognition rule 443 or a classification result 445 by carrying out feature extraction and classifications 442 and 442′ in accordance with a phenomenon enlightening a predicted anomaly at a learning time by carrying out a segment cutting out processes 441 and 441′ inputting sensor data 310 and making use of event data 105 and in accordance with countermeasure information 444 (part replacement, adjustment, resumption and others). To be more specific, FIG. 4C is a block diagram for a learning time whereas FIG. 4D is a block diagram for an operation time. The sensor data 310 is subjected to the feature extraction and classifications 442 and 442′ in accordance with the phenomenon and the countermeasure information 444. Thus, a predicted anomaly newly detected can be brought to a handling process promptly. In the classification, it is possible to make use of ordinary identification means such as a support vector machine, a k-NN tool or a decision tree. In the examples shown in FIGS. 4C and 4D, a segment is determined so as to include a predicted anomaly. However, a segment is selected to include all anomaly prediction points, ½ of anomaly prediction points or ¼ of anomaly prediction points.

FIG. 4E is a graph further showing countermeasures (categories) in a decreasing-frequency order starting with a countermeasure having the highest frequency by presenting a joint histogram of countermeasures for anomaly phenomena in order to represent a relation between the anomalies and the countermeasures. The vertical axis represents the frequency. In this case, a certain anomaly is taken as an example and actually executed countermeasures are shown. From such a relation, sensor data which is produced when an anomaly is generated is acquired and learned by adoption of the method shown in FIG. 4C (That is to say, parameters of the identification means are determined). In addition, when a predicted anomaly is detected, if the sensor data is classified into categories by making use of the learned data, at the prediction stage, a countermeasure that should be taken can be imaged. So far, even though the type of the anomaly can be identified, a countermeasure does not come to mind.

In addition, FIG. 4E is linked to the priority levels of countermeasures even when used alone and displaying it is meaningful. In the example shown in the figure, countermeasures having low frequencies also exist in no small measure. They are encompassed to be meaningful for an ability to look down upon.

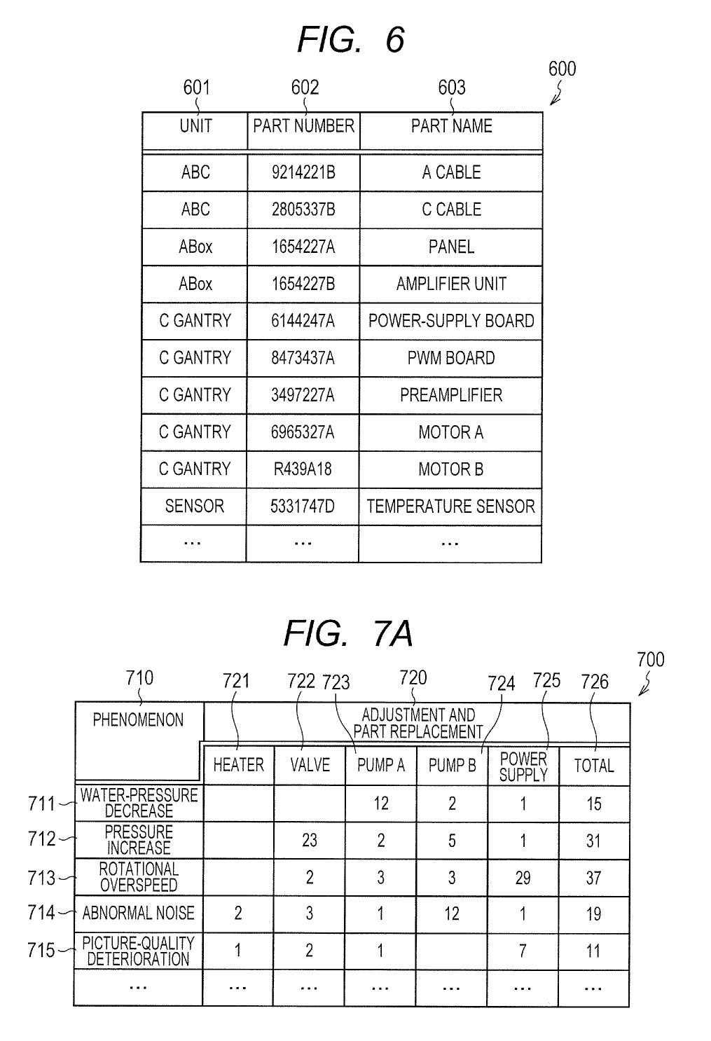

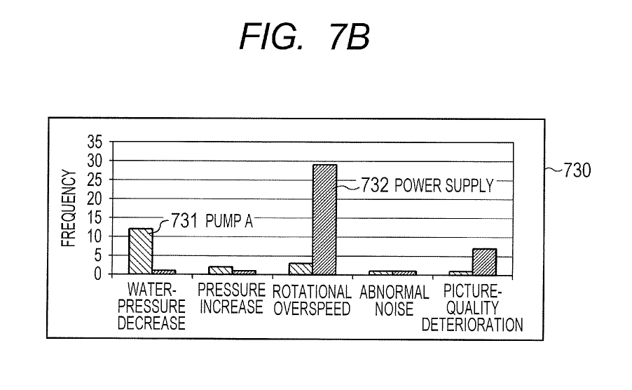

FIG. 5 shows alarm integration 502, field inspection existence/non-existence 503 and handling descriptions 504 for every alarm number 501. The handling descriptions 504 include reset 5041, adjustment 5042, part replacement 5043 and takeout inspection 5044. FIG. 6 is a part table 600 which typically has a unit column 601, a part-number column 602 and a part-name column 603. FIG. 7A is an inter-object association table 700 having a phenomenon column 710 and an adjustment/part replacement column 720. The inter-object association table 700 shows frequencies on the basis of bonding. The frequencies for these keywords are extracted and summed up to give a sum 726. The frequency data is used for creating a diagnosis model. It is to be noted that the phenomenon column 710 shows phenomena such as a water-pressure decrease 711, a pressure increase 712, a rotational overspeed 713, an abnormal noise 714 and a picture quality deterioration 715. These phenomena can also be classified into groups each provided for a member of the facility. In addition, usually, the picture quality deterioration 715 is further classified into details each provided for a facility in accordance with functional deteriorations or the like.

FIG. 7B shows a frequency pattern 730 provided for parts to serve as a pattern corresponding to phenomena. The figure shows sums of generation frequencies of phenomena, which occur when adjustment and/or replacement of a part are carried out, for an A pump 731 and a power supply 732. In actuality, keyword frequencies described in a work report can also be used. As an alternative, it is also possible to make use of keywords extracted on the basis of a result of an analysis carried out on an image recorded by typically a camera used by a person doing a work. The pattern of frequencies is a feature quantity of the bag-of-words method. It is possible to separate the adjustment and the part replacement from each other and find a sum for each of the adjustment and the part replacement or find sums independently of each other. Thus, each item of the frequency pattern is provided in a form allowing item addition and item editing.

It is to be noted that FIG. 7A shows results of operations carried out to find sums for the adjustment and the part replacement. However, it is also possible to adopt a co-occurrence concept and regard phenomena occurring at the same time as a pair or a group composed of 2 or more sets. Then, such a group is regarded as one phenomenon. This pertains to the phenomenon classification 412 shown in FIG. 4A. It is to be noted that the phrase stating ‘phenomena occurring at the same time’ means phenomena occurring within a time period determined in advance. There are a case in which the occurrence order is taken into consideration and a case in which the occurrence order is not be taken into consideration. If the occurrence order is taken into consideration, the law of causality has been borne in mind.

In addition, in FIG. 7B, each item of the frequency pattern 730 includes the number of inquiries issued by a person in charge of maintenance to a maintenance center and inquiry contents (described in a keyword).

The frequency pattern 730 comprising a variety of keyword types as described above can also be said to be a context representing, among others, the facility installation condition, the anomaly generation condition, the maintenance condition, the part replacement condition and past examples. A context, a placement condition and others are added to a keyword serving as a sole base for the conventional search operation. In a manner, such a search operation can be conceivably carried out. In other words, so far, it is written in the ‘if then’ form so that, in the search operation, the usage condition is not capable of achieving the target. As a result, there are many cases in which the diagnosis of the ‘then’ portion and its countermeasure are wasted in the end. However, such an ineffective keyword expression/usage condition can be expressed more flexibly by making use of a frequency pattern to provide a form in which the target can be conceivably achieved. Thus, in comparison with the diagnosis/countermeasure based on ‘if then’, it is possible to implement a diagnosis with a much higher degree of reliability.

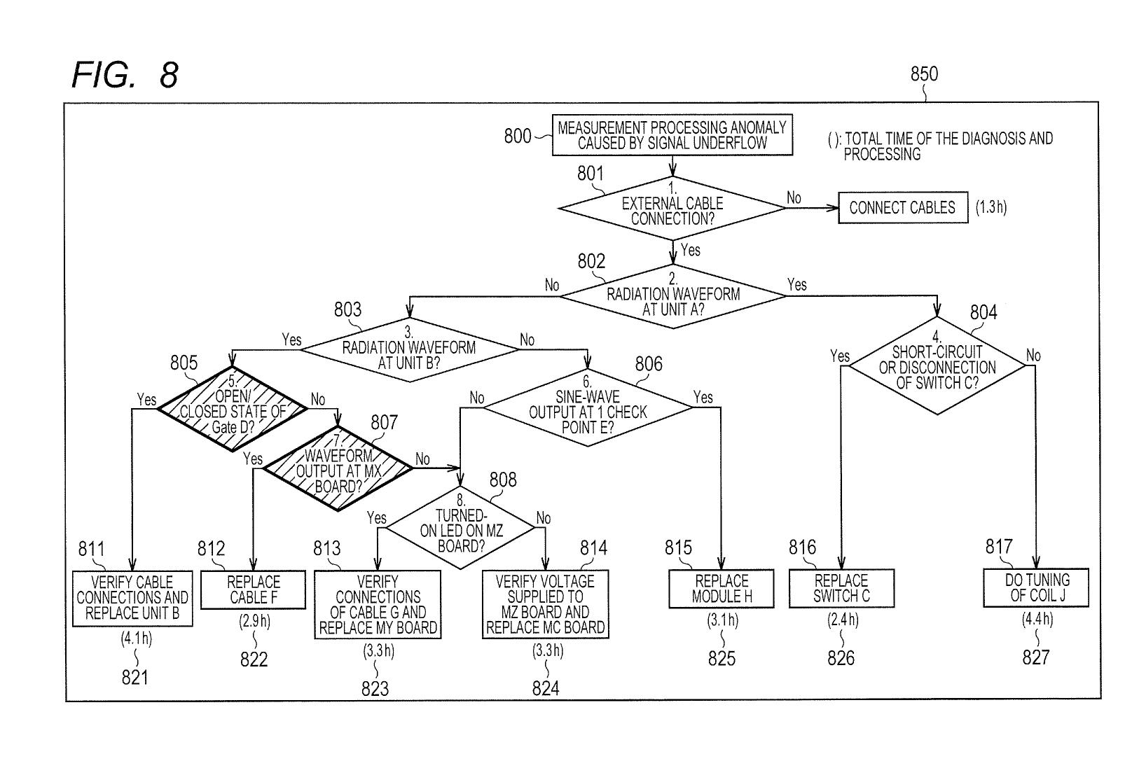

FIG. 8 shows a diagnosis fault tree displayed on a screen 850. Usually, when an ordinary service person including a new service person carries out a fault diagnosis, the person traces the fault tree from the upstream side in order to perform the diagnosis work. Thus, a proper countermeasure can be taken. In accordance with this method, the cause of the failure can be searched for exhaustively. However, there is raised a problem that it takes much time to carry out the work. Thus, it is not always necessary to trace the diagnosis fault tree from the upstream side. Instead, it is desirable to carry out the diagnosis work in a flexible manner in order to shorten the work time.

A procedure of creating a diagnosis fault tree is explained as follows.

### Step 1

A phenomenon leading to the anomaly handling such as replacement of a part is taken as an object. Things to be clarified include anomaly phenomena and candidates for handling works required to recover the phenomena, descriptions of diagnosis works required to narrow down the candidates, information necessary for diagnoses, diagnosis criteria and information on work items to be carried out next in accordance with determination results.

### Step 2

Unexhausted diagnosis works, handling works and points to be corrected are listed up and used as supplementary information by making use of maintenance-history information and setting a hearing meeting with the service department.

### Step 3

A hearing meeting with the service department is set in order to classify information necessary for diagnoses into information that can be acquired automatically or information that can be acquired manually through manual operations.

### Step 4

A hearing meeting with the service department is set in order to record information on standard work times it takes to carry out anomaly diagnosis works and anomaly handling works.

FIG. 8 shows an example of a phenomenon 800 which is a measurement processing anomaly caused by a signal underflow. This diagnosis fault tree shows an order to be followed by a person in charge of maintenance in actually carrying out works in a field in which the facility is installed. Verifications of connections of external cables, verifications of radiated waveforms and other verifications are determined as next actions. The figure shows branches 801 to 808. At the places of these branches 801 to 808, measurements of object units, visual contact verifications and others are implemented and branches to the downstream side are made in order to carry out next diagnoses. By repeating such branches, handlings 811 to 817 are reached. The handlings 811 to 817 are typically countermeasures and adjustments. In this case, as is the case with branch places 805 and 807, a sensor signal may allow a direct measurement to be carried out. In FIG. 8, the lengths of time it takes to carry out works are shown by numbers 821 to 827 each enclosed in parentheses. By regarding the time it takes to carry out a work as a cost, the work procedure can be optimized.

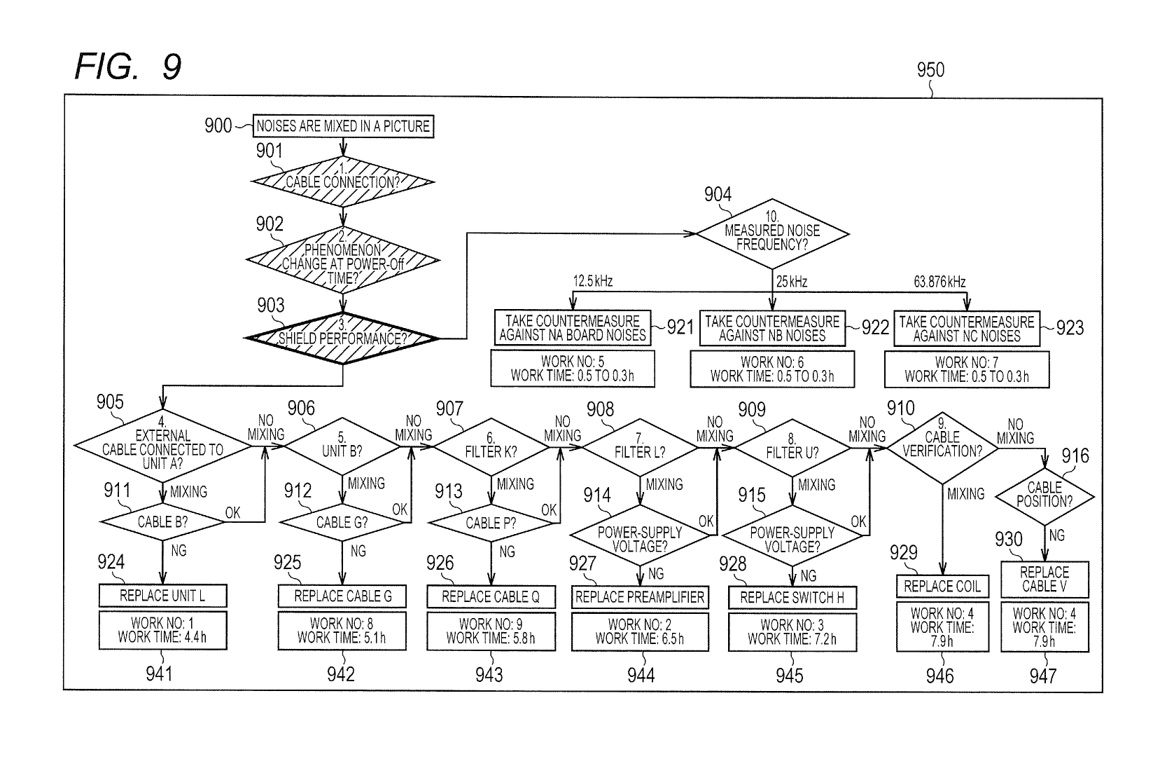

Likewise, FIG. 9 shows a diagnosis fault tree for a phenomenon 900 in which noises is mixed to a picture. At the places of branches 901 to 910, measurements of object units, visual contact verifications and others are implemented. At the places of branches 911 to 916, on the other hand, cable connections and phenomenon changes occurring at power-supply off times are checked in order to determine whether or not to continue to countermeasures 921 to 930 which are each determined as a next action. In addition, each of blocks 941 to 947 includes the length of time it takes to carry out the work of a countermeasure.

In these diagnosis fault trees, if a signal to be checked at a branch point can be acquired automatically, the signal can be added to sensor data.

An important viewpoint in a diagnosis fault tree is to set up an optimum route. An optimum route is a route set up by a variety of cost viewpoints such as part costs and a work time. The optimum route does not necessarily show a first route only. Comparison with a second route may also be conceivably displayed. In addition, the work-end times of the first and second routes may also be presented. On the top of that, a virtual cost incurred in the case of an incorrect branch and a do-over route may also be presented. A virtual cost is a work cost caused by an end-time difference and a work cost incurred as a part spending for replacement of a part which does not naturally need to be replaced. They are carried out by, for example, referring to high-frequency work items shown in FIG. 4E.

In addition, a display screen may show all diagnosis fault trees or only portions surrounding a work of interest in a diagnosis fault tree.

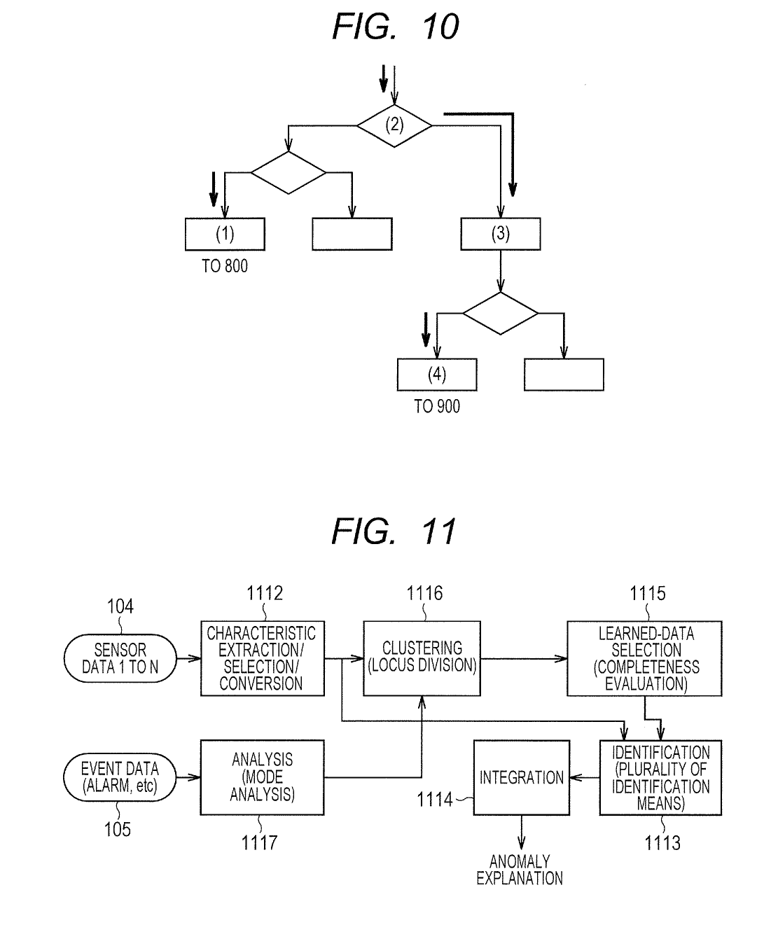

For this diagnosis fault tree, FIG. 10 shows the state of a diagnosis based on classification of sensor data according to the present invention. Numbers shown in the figure each represent a typical countermeasure required in accordance with a result of classifying sensor data on the basis of typical past countermeasures in accordance with the method shown in FIG. 4C. In addition, the numbers also represent the priority levels of works (branches) which should be started as a maintenance work in the field with the monitoring center carrying out a rough diagnosis. The priority levels are shown to the service person. The example shown in FIG. 10 is an example requesting the service person to check countermeasures in an order starting with that indicated by number (3).

In a variety of phenomena, by classifying sensor data on the basis of past examples, the sensor data is viewed from the phenomenon point of view or the countermeasure point of view. Thus, in the diagnosis flows shown in FIG. 10, it is possible to show a proper work procedure indicating a place to start. Therefore, the time it takes to carry out works in the field can be reduced substantially. In addition, if works are carried out on the basis of the diagnosis fault tree, the works can be implemented without errors and without reaching a deadlock. If the method shown in FIG. 4C is adopted, it is possible to give information most appropriate for the method.

FIG. 11 shows a typical multivariate analysis which is example-based anomaly detection taking a multi-dimensional sensor signal as an object by adoption of a method for detecting an anomaly on the basis of an example base. Reference numeral 104 denotes sensor data 1 to sensor data N which are acquired by the multi-dimensional time-series signal acquisition section 103 shown in FIG. 1. The anomaly detection/diagnosis system 100 according to the present invention receives the sensor signal 104. The sensor data 104 is subjected to a characteristic extraction/selection/conversion process 1112, a clustering process 1116 and a learned-data selection process 1115. For the sensor data 104 received in the form of a multi-dimensional time series, an identification section 1113 supplies measured sensor data serving as an incorrect value when seen from normal data or its synthesis value to an integration section 1114. When the integration section 1114 detects a generated anomaly or a predicted anomaly, the diagnosis described above is started. The diagnosis includes collation of the degree of contribution to the failure phenomenon and a frequency pattern based on past examples. The collation is collation of not only the degree of contribution, but also a frequency pattern which is a time-axis sum.

The clustering process 1116 is carried out to classify the sensor data into some categories by mode in accordance with an operating state and the like. In addition to the sensor data, event data (ON/OFF control of the facility, a variety of alarms, periodic inspection and adjustment of the facility and other data) 105 may be used. In addition, on the basis of their analysis results, learned data is selected and an analysis of the anomaly is carried out. As an input to the clustering process 1116, the event data 105 can also be classified into some categories for modes on the basis of the event data 105. It is an analyzer 1117 that analyzes and interprets the event data 105.

In addition, the identification section 1113 carries out identification making use of a plurality of identification means. The results of the identification are integrated by the integration section 1114 in order to implement the detection of the anomaly with higher robustness. The integration section 1114 outputs a message explaining the anomaly.

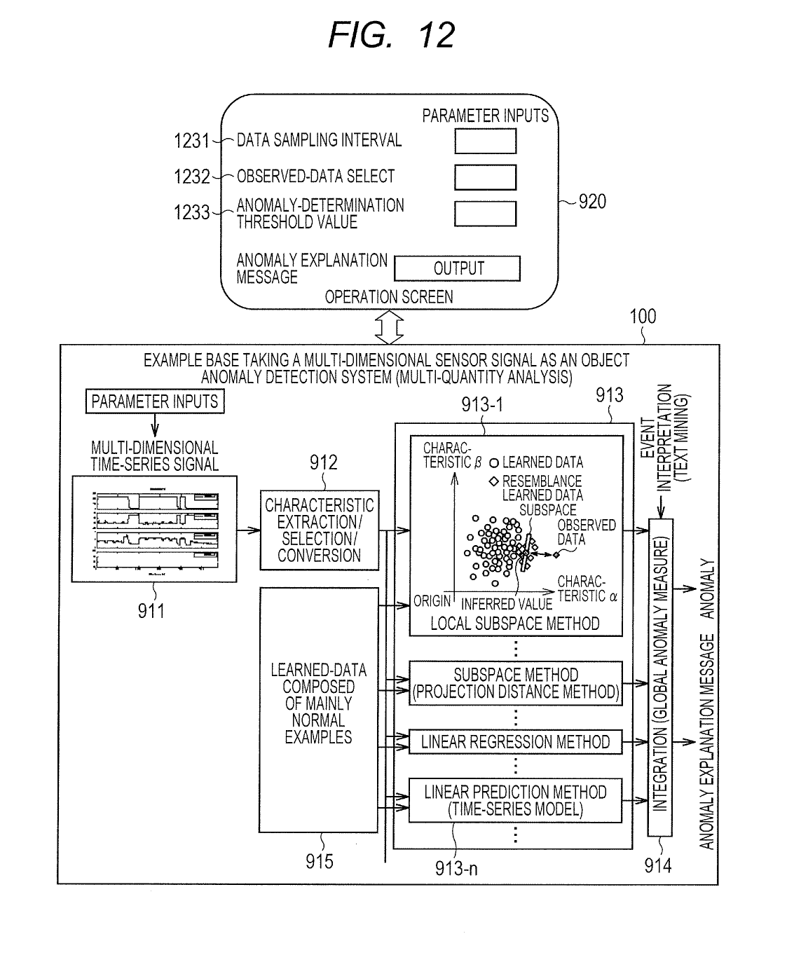

FIG. 12 shows the internal configuration of the anomaly prediction/diagnosis system 100 for carrying out anomaly detection processing based on an example base. In this anomaly detection, reference numeral 912 denotes a characteristic extraction/selection/conversion section. The characteristic extraction/selection/transformation section 912 receives a multi-dimensional time-series signal 911 based on a variety of sensor signals 104 acquired by the multi-dimensional time-series signal acquisition section 103 and processes the multi-dimensional time-series signal 911. Reference numeral 913 denotes an identifier whereas reference numeral 914 denotes an integration processing section (global anomaly measure). On the other hand, reference numeral 915 denotes a learned-data storage section used for storing learned data composed of mainly normal examples.

The characteristic extraction/selection/transformation section 912 reduces the number of dimensions of the multi-dimensional time-series signal received from the multi-dimensional time-series signal acquisition section 911. Then the multi-dimensional time-series signal is identified by a plurality of identification means 913-1, 913-2, - - - and 913-n which are employed in the identifier 913. The integration processing section 914 (global anomaly measure) determines the global anomaly measure. The learned data stored in the learned-data storage section 915 as data composed of mainly normal examples is also identified by the identification means 913-1, 913-2, - - - and 913-n and used in the determination of the global anomaly measure. In addition, the learned data stored in the learned-data storage section 915 as data composed of mainly normal examples itself is subjected to a selection process of taking or discarding the data. In this way, the learned data is stored in the learned-data storage section 915 and updated in order to improve the precision.

FIG. 12 also shows the screen 920 of an operation PC. The screen 920 is displayed on the input section 123 for receiving parameters entered by the user. The parameters entered by the user to the input section 123 include a data sampling interval 1231, an observed data select 1232 and an anomaly determination threshold value 1233. The data sampling interval 1231 is an interval at which data is to be acquired. The data sampling interval 1231 is typically expressed in terms of seconds.

The observed data select 1232 is an instruction indicating which sensor signals are to be used. The anomaly determination threshold value 1233 is a threshold value for binary conversion of a value representing the degree of anomaly, which is computed and expressed as a variance/deviance from a model, a deviation value, an estrangement degree and an anomaly measure.

The identifier 913 shown in FIG. 12 includes some prepared identification means 913-1, 913-2, - - - and 913-n. The integration processing section 914 is capable of determining a majority of the identification means 913-1, 913-2, - - - and 913-n. That is to say, it is possible to apply ensemble learning making use of the identification means 913-1, 913-2, - - - and 913-n. For example, the first identifier 913-1 is the projection distance method whereas the second identifier 913-2 is the local subspace method. On the other hand, the third identifier 913-3 is the linear regression method. Any arbitrary identifier can be adopted as long as the identification method is based on example data.

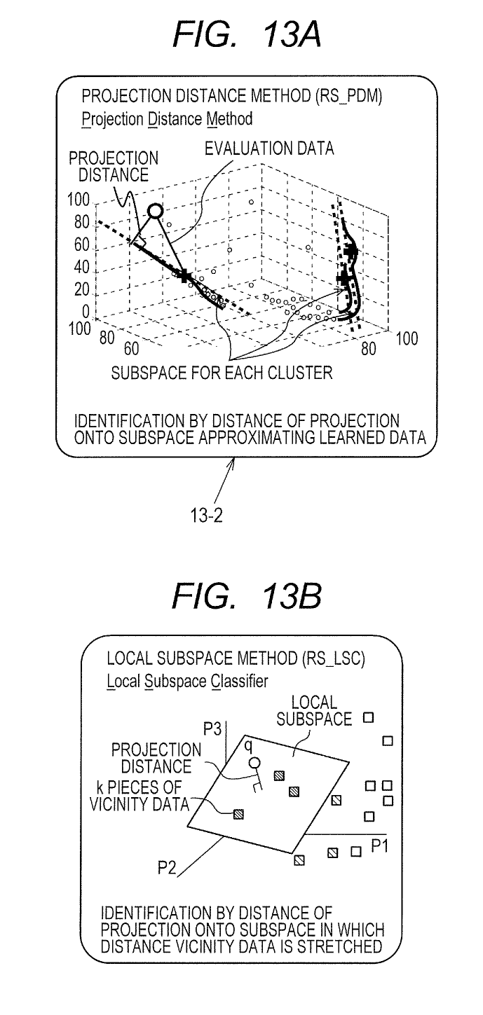

FIGS. 13A to 13C are diagrams referred to in description of typical identification methods adopted in the identifier 913. To be more specific, FIG. 13A is a diagram referred to in description of the projection distance method. The projection distance method is an identification method making use of the distance of projection onto a subspace approximating learned data.

In accordance with the projection distance method, first of all, an average mᵢ of the learned data {xᵢ} for each cluster and a variation matrix Σᵢ are found by making use of the following equation:

$${m}_{1} = \frac{1}{{n}_{i}} {Σ}_{i ∈ ω} {x}_{1} , {Σ}_{i} = \frac{1}{{n}_{i}} {Σ}_{j ∈ ω} ( {x}_{j} - {m}_{i} ) {( {x}_{j} - {m}_{i} )}^{T} \qquad ( 1 )$$

In the above equation, symbol nᵢ denotes the number of learned patterns pertaining to a cluster ωᵢ.

Then, an eigenvalue problem of the variation matrix Σᵢ is solved and, on the basis of a cumulative contribution ratio, a matrix Uᵢ arranging eigenvectors corresponding to the r eigenvalues starting with the largest one is taken as a normal orthogonal base of an affine subspace of the cluster ωᵢ. The minimum value of the projection distance to the affine subspace is defined as an anomaly measure of an unknown pattern x. In spite of 1 cluster classification making use of only normal learned data, the learned data itself includes different conditions such as the ON/OFF operating conditions. Thus, for the learned data, a subspace is generated with k-vicinity data close to observed data taken as one cluster. At that time, learned data whose distance from the observed data falls in a range determined in advance is selected (an RS method or a Range Search method). In addition, L (times t−t1 to t+t2, t1 and t2 are sampling consideration) pieces of learned data are also used to generate a subspace (time extension RS method). The L pieces of learned data are data which should correspond to variations of the transient time and leads ahead of or lags behind the selected data in the direction of the time axis. On the top of that, the projection distance is selected so that its value is smallest among those in a range from a smallest count to a selection count.

For 1 point of observed data, minimum learned data is selected. With only 1 point of observed data, however, whether or not the sensitivity is highest is not clear. Thus, also for the observed data, a subspace is generated. In the learned data, a subspace is generated from L×k sets (or smaller) of data selected by adoption of the time extension range search method. For the observed data, however, the length of the window segment is a degree of freedom and the selection is key to it. If the length of the window segment is increased, the variations of the data are caught. Due to handling independent of times, however, the amount of fear that a variation cannot be detected increases so that, furthermore, handling of the learned data can no longer be carried out.

On the basis of the dimension count n of the subspace in which learned data is stretched, a minimum window segment of the observed data is determined. The dimension count n is computed from the cumulative contribution ratio. Under a condition that the number of pieces of observed data is equal to the maximum (n+1), on the basis of the dimension count n, the window segment length M of the observed data is determined in an exploratory manner and the subspace is generated. Then, cos θ or its square is computed where θ denotes an angle formed by subspaces. A planning method is characterized in that, in accordance with this method, for time-series data, first of all, a minimum learning subspace is generated, then, from the similarity standpoint and the time-window standpoint, observed data is selected properly and, finally, similar subspaces are generated successively.

It is to be noted that, in the projection distance method, the center of gravity of classes is taken as an origin. An eigenvector obtained by applying the KL expansion to a covariance matrix of classes is used as a base. A variety of subspace methods have been proposed. If the method is a method having a distance scale, the degree of deviation can be computed. It is to be noted that, also in the case of the density, by making use of its quantity, the degree of deviation can be determined. In the projection distance method, the length of the orthogonal projection is found. Thus, the projection distance method makes use of a similarity measure.

As described above, in a subspace, a distance and a similarity degree are computed whereas the degree of deviation is evaluated. In the subspace method such as the projection distance method, due to identification means based on a distance, as a learning method for a case in which anomaly data can be used, it is possible to make use of metric learning for learning a distance function and vector quantization for updating a dictionary pattern.

FIG. 13B shows another example of the projection distance method adopted in the identifier 913. This example is a method referred to as a local subspace method. The local subspace method is an identification method based on a projection distance to a subspace in which short-distance data is stretched. In accordance with the local subspace method, first of all, k multi-dimensional time-series signals close to an unknown pattern q (a most recent observed pattern) are found. Then, a linear manifold for which a closest pattern of classes serves as an origin is generated. Finally, the unknown pattern is classified into a class which makes the projection distance to the linear manifold shortest. The local subspace method is also one of subspace methods. The signal count k representing the number of multi-dimensional time-series signals is a parameter. In detection of an anomaly, the distance from the unknown pattern q (a most recent observed pattern) to the normal class is computed and used as a variation (or a residual error).

In this method, for example, an orthographic point projected from the unknown pattern q (a most recent observed pattern) onto a subspace created by making use of the k multi-dimensional time-series signals can also be computed as an inferred value.

In addition, the k multi-dimensional time-series signals can also be rearranged into an order starting with the signal closest to the unknown pattern q (a most recent observed pattern) and multiplied by weights inversely proportional to the distances in order to compute inferred values of the signals. By adoption of the projection distance method, the inferred values of the signals can also be computed as well.

The parameter k is normally set at 1 value. If the processing is carried out by setting the parameter k at a value which can be changed to one of several other values, however, object data is selected in accordance with the degree of similarity. In this case, since comprehensive determination is made from their results, the method becomes more effective.

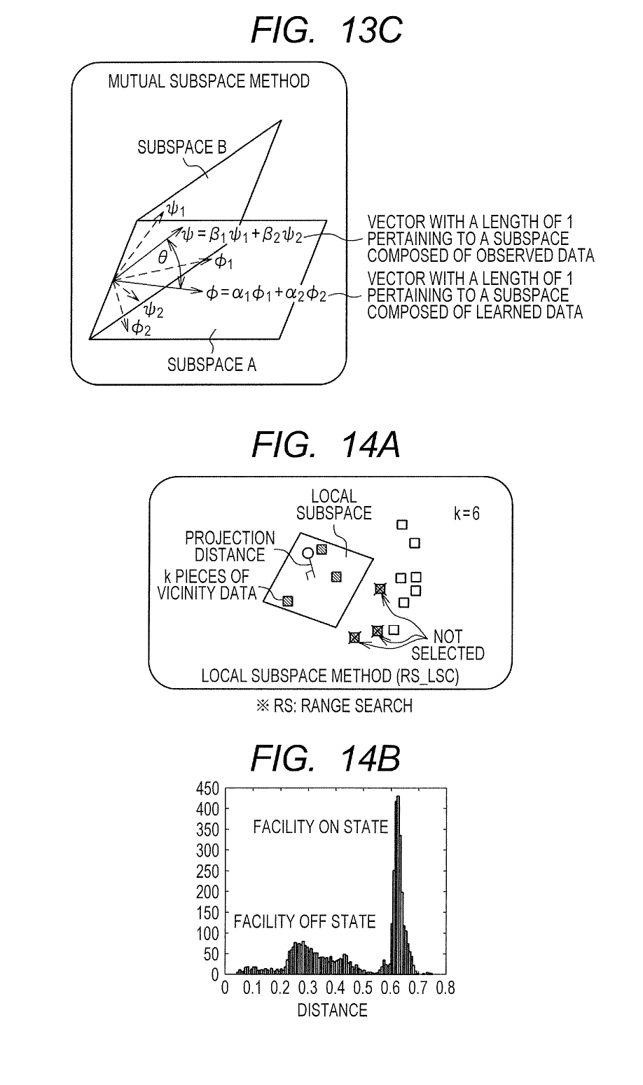

In addition, as shown in FIG. 14A, as the value of the parameter k, learned data is selected. The selected learned data must have a value proper for every observed data and the distance between the selected learned data and the observed data is within a range determined in advance. On the top of that, the number of pieces of learned data can be increased sequentially from a minimum value to a select value and learned data having a shortest projection distance is selected.

What is described above can be applied to the projection distance method. To put it concretely, the procedure is described as follows.

1: Compute distances from the observed data to the learned data and rearrange the distances in an increasing order.
2: If the distance d<a threshold value th and the distance d is not greater than the parameter k, select the learned data.
3: Compute the projection distance for the range j=1 to k and output the minimum value.

The threshold value th used in the procedure described above is determined experimentally from the frequency distribution of the distance. FIG. 14B shows a distribution seen from observed data as the frequency distribution of the distance for the learned data. In this example, the frequency distribution of the distance for the learned data is a curve having a form of 2 mountains corresponding to respectively the on and off states of the facility. The valley between the 2 mountains represents a transient period from the on state to the off state of the facility or the reversed transient period from the off state to the on state of the facility.

This notion is a concept referred to as a range search (RS) concept. This notion is thought to be applied to selection of learned data. The range search concept of learned-data selection can be applied also to the methods disclosed in patent documents 1 and 2. It is to be noted that, in the local subspace method, even if abnormal values are mixed a little bit, by setting the local-subspace, the effects are reduced substantially.

It is to be noted that, as shown in none of the figures, in identification referred to as an LAC (Local Average Classifier) method, the center of gravity for k neighborhood data is defined as a local subspace. Then, the distance from the unknown parameter q (a most recent observed pattern) to the center of gravity is computed and used as a variance (or a residual error).

FIG. 13C is a diagram referred to in description of a technique called a mutual subspace method. A subspace is used for modeling not only learned data, but also observed data. In this case, the observed data is N pieces of time-series data traced back to the past. In the mutual subspace method, an eigenvalue problem of a self correlation matrix A of data is solved. The self correlation matrix A is expressed by an equation given as follows:

A=1/N(Σφφ^{T}) (2)

In FIG. 13C, notations φ and ψ denote normal orthogonal base of a subspace. In addition, cos θ represents the similarity. The degree of similarity is used to identify observed data. The mutual subspace and its extension are described in documents such as “Actions of Nuclear Non-linear Mutual Subspace Method” authored by Seiji Horita, Tomokazu Kawahara, Osamu Yamaguchi and Ei Sakano, a communication technical report, PRMU 2010, Vol. 110, No. 187, pp. 1 to 6, September 2010.

The example shown in FIG. 12 as a typical identification method of the identifier 913 is provided as a program. It is to be noted that, if thought simply as a one-class identification problem, identification means such as a one-class support vector machine can also be applied. In this case, kernel conversion such as a radial basis function can be used. The kernel conversion is conversion for mapping onto a high-order space.

In the one-class support vector machine, the side close to the origin is a deflected value, that is, an anomaly. However, the support vector machine is capable of keeping up with even a high dimension of the feature quantity. Nevertheless, there is a demerit that if the learned-data count increases, the huge amount of computation is required.

In order to deal with the demerit, it is possible to apply typically a technique announced in the MIRU 2007 (which is a Meeting on Image Recognition and Understanding 2007). The document describing the technique is IS-2-10, “One-class Identification Means Based on Pattern Adjacency” authored by Takekazu Kato, Mami Noguchi, Toshikazu Wada (Wakayama University), Kaoru Sakai and Shunji Maeda (Hitachi). This announced technique offers a merit that, even if the learned-data count increases, the huge amount of computation is not required.

By expressing a multi-dimensional time-series signal by a low-dimensional model as described above, a complicated state can be decomposed and expressed by a simple model. Thus, there is provided a merit that the phenomenon is easy to understand. In addition, in order to set a model, it is not necessary to prepare data completely as is the case with the methods disclosed in patent documents 1 and 2.

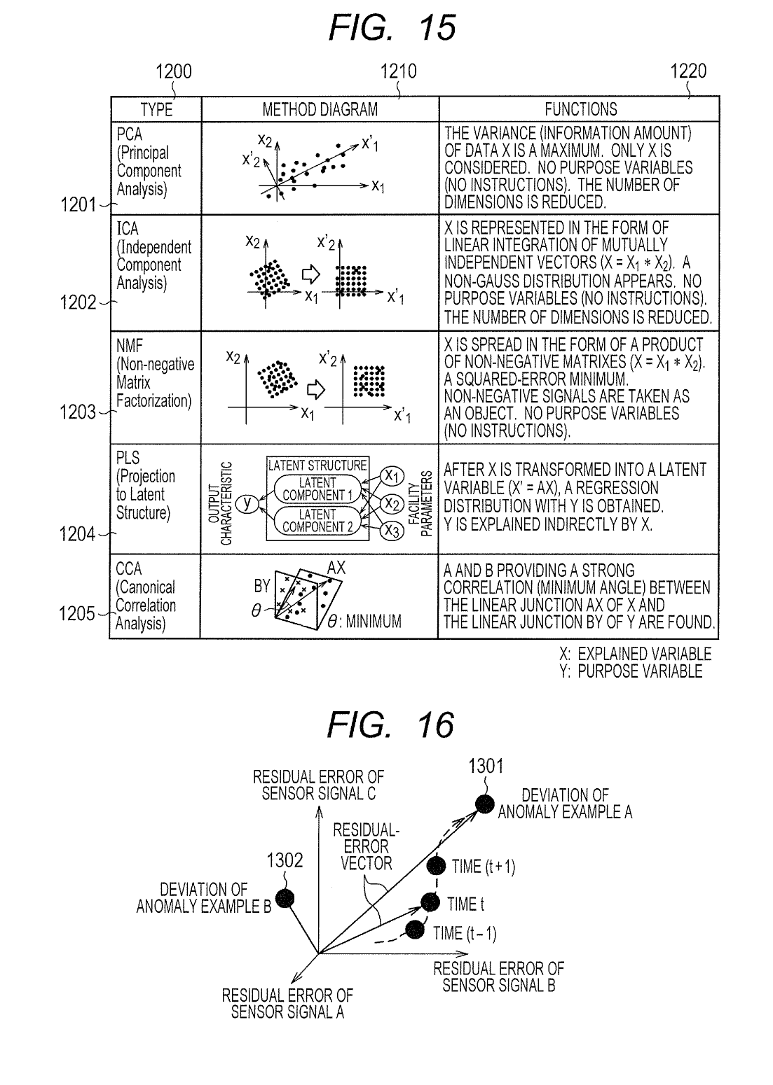

FIG. 15 shows an example of characteristic conversion 1200 for reducing the number of dimensions of sensor data 1 to N denoted by reference numeral 104. The sensor data 1 to N is a multi-dimensional time-series signal shown in FIG. 11 as a signal acquired by the multi-dimensional time-series signal acquisition section 103. In addition to a principal component analysis 1201, it is also possible to apply some techniques such as an independent component analysis 1202, a non-negative matrix factor decomposition 1203, a projection to latent structure 1204 and a canonical correlation analysis 1205. FIG. 15 shows both method diagrams 1210 and functions 1220.

The principal component analysis 1201 is referred to as a PCA for linearly transforming a multi-dimensional time-series signal having a dimension count M into an r-dimensional time-series signal having a dimension count r. The principal component analysis 1201 is also used for generating an axis with a maximum number of variations. KL transformation can also be carried out. The dimension count r is determined on the basis of a value serving as a cumulative contribution ratio obtained by dividing an eigenvalue by the sum of all eigenvalues. The divided eigenvalue is a value obtained by arranging eigenvalues computed by a principal component analysis in a descending order and summing up them by starting with a large one.

The independent component analysis 1202 has an effect of a technique referred to as an ICA (Independent Component Analysis) and used for actualizing a non-Gaussian distribution. The non-negative matrix factor decomposition is referred to as NMF (Non-negative Matrix Factorization). In NMF, sensor signals given in the form of a matrix are decomposed into non-negative elements.

The characteristic conversion method which is indicated on the column of the function 1220 as without a teacher is an effective transformation method in a case that an item is provided is an item with few anomaly examples and not possible to activate it. In this case, an example of the linear transformation is shown. Non-linear transformation can also be applied.

The characteristic transformation described above includes normalization for normalizing by making use of standard deviations and is implemented at the same time by arranging learned data and observed data. By doing so, learned data and observed data can be handled on the same level.

FIG. 16 is an explanatory diagram referred to in description of a prediction detection technique developed for anomaly generation as a technique making use of a residual error pattern. FIG. 16 shows a technique of similarity-degree computation of a residual error pattern. FIG. 16 expresses deviations as loci in a space. The expressed deviations are deviations of a sensor signal A, a sensor signal B and a sensor signal C which are generated at points of time from a normal center of gravity. This normal center of gravity corresponds to the normal center of gravity of pieces of learned data found by adoption of the local subspace method. To put it accurately, the axes represent principal components.

In FIG. 16, a residual error series of observed data is shown as a dashed line having an arrow and passing through times (t−1), t and (t+1). The degree of similarity for each of the observed data and anomaly examples can be inferred by computing the inner product (A*B) of their deviations A and B. In addition, the inner product (A*B) can be divided by the magnitude (norm) and the degree of similarity can be inferred by the angle θ. For a residual error pattern of the observed data, the degree of similarity is computed and, by making use of its locus, an anomaly predicted to be generated is inferred.

To put it concretely, FIG. 16 shows a deviation 1301 of an anomaly example A and a deviation 1302 of an anomaly example B. Focusing on a deviation series pattern of observed data including the times (t−1), t and (t+1) on the dashed line having an arrow, at the time t, it is close to the anomaly example B. From its locus, however, it is possible to predict generation of the anomaly example A instead of the anomaly example B. If there is no past anomaly example corresponding to the predicted anomaly in the past, the predicted anomaly can be determined to be a new anomaly. In addition, a space shown in FIG. 16 is divided by a zone having the shape of a circular cone having a vertex coinciding with the origin and, then, an anomaly can be identified by making use of the zone.

In order to predict an anomaly example, locus data of a deviation (residual error) time series up to the generation of the anomaly example is stored in a database in advance. Then, the degree of similarity between the deviation (residual error) time-series pattern of the observed data and the deviation (residual error) time-series pattern stored in the locus database as a pattern for locus data can be computed in order to detect predicted generation of an anomaly.

If such a locus is displayed to the user through a GUI (Graphical User Interface), the state of generation of an anomaly can be visually expressed and reflected with ease in a countermeasure or the like.

If only comprehensive residual errors are traced and development with the lapse of time is ignored, an anomaly phenomenon is difficult to understand. If the development of a residual error vector with the lapse of time is followed, however, the phenomenon can be picked up and understood. Theoretically, by carrying out processing to sum up vectors of each of several events forming a compound event, it is possible to detect prediction of generation of an anomaly for the compound event and the fact that a residual error vector accurately expresses an anomaly can be understood. If the loci of past anomaly examples such as the past anomaly examples A and B have been stored in a database as known information, an observed locus of an anomaly can be collated with the stored loci in order to identify (diagnose) the type of the anomaly.

In addition, if FIG. 16 is viewed as generation of a residual error vector in a fixed time window, it can be expressed as a frequency. If it can be treated as a frequency, it is possible to acquire frequency distribution information having a form like the one shown in FIG. 7B. It can thus be handled as the frequency of appearance of a keyword for the phenomenon. That is to say, it can be used in a diagnosis. In order to treat the residual error vector shown in FIG. 16 as a frequency, each axis of FIG. 16 is segmented into a fixed width and determination as to whether or not it is included in cubic zones is made to create a frequency distribution. In FIG. 16, a 3-dimensional frequency distribution is obtained or, normally, a multi-dimensional frequency distribution is obtained. By arrangement along a vertical column or the like, however, 1-dimensionalization (vectorization) is possible so that it can be handled as an ordinary frequency distribution or a frequency pattern.

FIG. 17 shows the hardware configuration of the anomaly detection/diagnosis system 100. As shown in the figure, this system is configured to include a processor 120, a database (DB) 121, a display section 122 and an input section (I/F) 123. The processor 120 for carrying out detection of an anomaly inputs sensor data 104 from typically an engine serving as an object and carries out typically recovery of defective values. The processor 120 then stores the sensor data 104 in the DB 121. The processor 120 carries out detection of an anomaly by making use of the acquired observed sensor data 104 and DB data stored in the DB 121 which is used for storing learned data. The display section 122 displays various kinds of information and outputs a signal indicating the existence or the non-existence of an anomaly. The display section 122 is also capable of displaying a trend. In addition, the display section 122 is also capable of displaying a result of an interpretation of an event. On the top of that, the processor 120 makes an access to the DB 121 used for storing maintenance-history information and the like in order to search the DB 121 for a keyword. The processor 120 then retrieves the keyword found in the search in order to generate a diagnosis model used for diagnosing an anomaly. Then, the processor 120 displays a result of the anomaly diagnosis on the display section 122. In particular, for a fault tree, the processor 120 classifies sensor data as seen from the countermeasure and part replacement points of view and, at the stage of detecting a predicted anomaly, indicates typically a branch point which should be checked initially in an operation carried out on the facility.

Results of a diagnosis include a diagnosis model shown in FIGS. 4A to 4E. That is to say, the figures show, among others, a result of a diagnosis of a phenomenon, a result of classification of the phenomenon and the diagnosis model. In addition, the display also includes various kinds of information shown in FIGS. 5, 6 and 7A as well as 7B. In particular, the frequency histogram shown in FIG. 7B is an important display factor serving as information that makes the frequency pattern shown in FIG. 7A visible. A portion of a context is selected and displayed. In this case, the selected and displayed context is a context representing, among others, a facility installation condition, an anomaly generation condition, a maintenance condition, a condition leading to replacement of a part and past examples. They can be edited at a standpoint of item margins or the like.

Separately from the hardware described above, a program to be installed in the hardware can be provided to the customer through a program recording medium or an online service.

A skilled engineer or the like is capable of making use of the DB 121. In particular, anomaly examples and countermeasure examples can be stored in the DB 121 as past experiences. To be more specific, the DB 121 can be used for storing (1) learned data (normal data), (2) anomaly data, (3) countermeasure descriptions and (4) fault-tree information. The DB 121 is structured so that a skilled engineer or the like is capable of manually modifying the data stored in the DB 121. Thus, a sophisticated and useful database can be provided. In addition, a data operation is carried out by automatically moving learned data (pieces of data and the position of the center of gravity) in accordance with generation of an alarm and/or replacement of a part. In addition, acquired data can be added automatically. If the data of an anomaly exists, a technique such as the generalization vector quantization can be applied to movements of the data.

In addition, the loci of the past anomaly examples A and B and the like explained earlier by referring to FIG. 16 are stored in the DB 121 and the type of an anomaly is identified (or diagnosed) by collation with the loci. In this case, the loci are expressed as data in an N-dimensional space and stored. Data is processed by the processor 120 and displayed by the display section 122 in accordance with requests made by the input unit (I/F) 123.

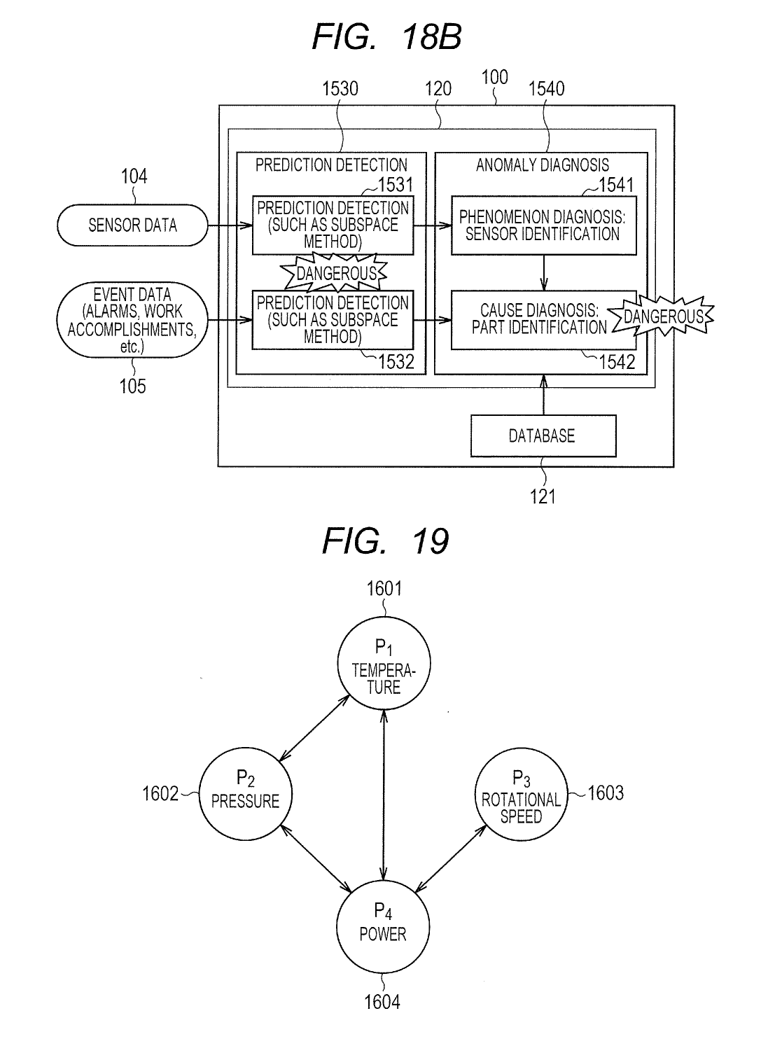

FIGS. 18A and 18B show detection of an anomaly and a diagnosis after the detection of the anomaly. In FIG. 18A, a time-series signal (a sensor signal) received from the multi-dimensional time-series signal acquisition section 103 receiving the signal from a facility 1501 is subjected to signal processing before being subjected to characteristic extraction/classification 1524 of the time-series signal 104 in the processor 120 in order to detect an anomaly. The number of facilities 1501 is not limited to one. That is to say, a plurality of facilities 1501 can also be targeted as one object. At the same time, supplementary information such as an event 105 of maintenance of the facilities is taken in in order to detect an anomaly with a high degree of sensitivity. In this case, the event 105 is an alarm, a work accomplishment or the like. To put it concretely, the event 105 can be activation of a facility, termination of a facility, setting of an operating condition, various kinds of failure information, various kinds of warning information, periodic inspection information, an operating environment such as the temperature of the installation site, a cumulative operating time, part replacement information, adjustment information or cleaning information to mention a few.

In FIG. 18A, the waveform 1525 of time-series data shown in the characteristic extraction/classification 1524 of the time-series signal 104 represents an observed signal whereas an anomaly detected in this exemplary embodiment is shown by a circular mark 1526 as a predicted anomaly. In the case of a predicted anomaly, the measure of anomaly is at least equal to a threshold value determined in advance (or the measure of anomaly exceeds a threshold value a number of times exceeding a number set in advance). In such a case, the predicted existence of an anomaly is determined. In this example, prior to termination of a facility, a predicted anomaly can be detected and a countermeasure which should be taken can be implemented.

As shown in FIG. 18B, if a prediction detection section 1530 of the processor 120 employed in the anomaly prediction/diagnosis system 100 is capable of detecting an anomaly as a predicted one at an early time, prior to termination of the operation due to a failure caused by the anomaly, some countermeasures can be taken. Then, the sensor data 104 is processed and the predicted anomaly is detected (1531) by adoption of the subspace method or the like. Subsequently, event data 105 is input and event-array collation and the like are added in order to comprehensively determine whether or not the predicted anomaly indeed exists (1532). On the basis of this predicted anomaly, by adoption of the methods explained earlier by referring to FIGS. 4A to 4E, an anomaly analysis section 1540 carries out an anomaly analysis in order to identify candidates for failing parts and infer a future time at which the parts fail, causing the operation to be terminated. Then, the required parts are prepared as replacement parts to be installed with a correct timing.

The anomaly analysis section 1540 is easy to understand if the reader thinks that the anomaly analysis section 1540 comprises a phenomenon analysis section 1541 and a cause analysis section 1542. The phenomenon analysis section 1541 is a section for carrying out a phenomenon analysis to identify a sensor including a predicted anomaly and for classifying anomalies from the countermeasure point of view and the adjustment point of view. On the other hand, the cause analysis section 1542 is a section for identifying a part which most likely causes a failure. The prediction detection section 1530 provides the anomaly analysis section 1540 with a signal indicating whether or not an anomaly exists and information on feature quantities. On the basis of the signal indicating whether or not an anomaly exists and the information on feature quantities, the phenomenon analysis section 1541 employed in the anomaly analysis section 1540 carries out a phenomenon analysis by making use of information stored in the DB 121. The phenomenon analysis section 1541 also classifies phenomena. In addition, the phenomenon analysis section 1541 also classifies sensor data from, among others, the adjustment point of view and the countermeasure point of view. That is to say, on the basis of the methods explained earlier by referring to FIGS. 4A to 4E, the cause analysis section 1542 makes use of information stored in the DB 121 in order to recommend places to be checked, identify places to be adjusted, and carry out analysis to identify a part to be replaced.

FIG. 19 shows an example of creating a network of sensor signals from information on the quantity of an obtained effect on anomalies of the sensor signals. With regard to sensor signals such as the basic temperature 1601, a pressure 1602, the rotational speed 1603 of a motor or the like and an electric power 1604, on the basis of the rates of the quantity of an effect on the anomaly, weights can be applied to the sensor signals. These relations are also utilized as a keyword in the analysis model explained earlier by referring to FIGS. 4A to 4E.

If such a relevant network is available, the signal connection, the signal co-occurrence and the signal correlation, which are not intended by the designer, could be clearly shown. Thus, such a relevant network is useful for an analysis of an anomaly. Such a network is generated at scales such as correlation, similarity, distance, cause-effect relationship and phase-lead/phase-lag in addition to the quantity of an effect on anomalies of sensor signals. Object-Facility Models and Network of Selected Sensor Signals

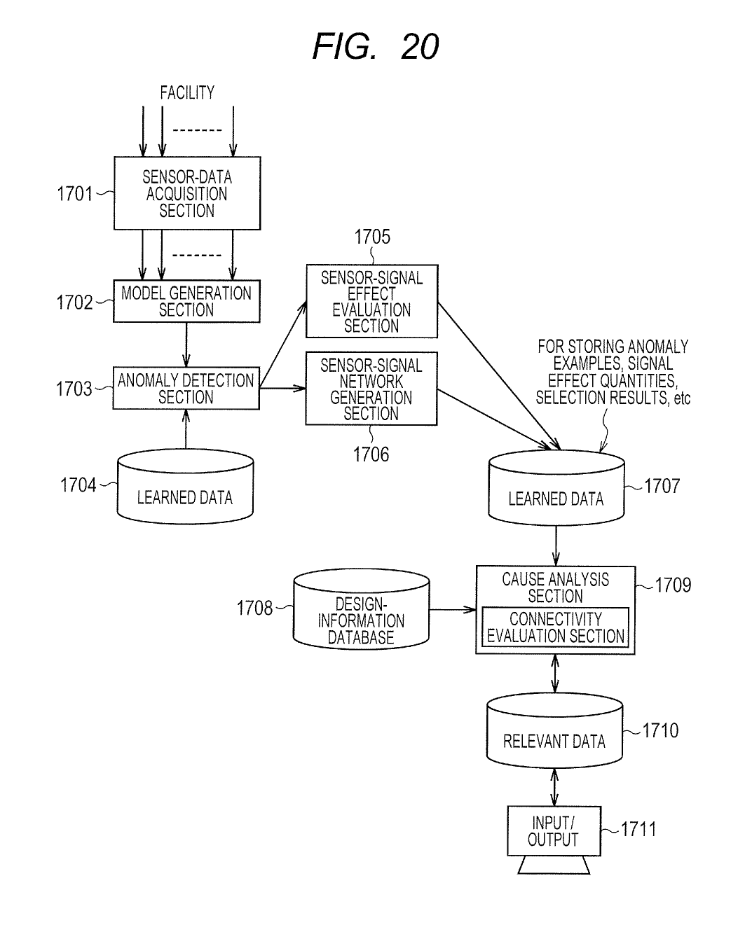

FIG. 20 shows the configurations of the anomaly detection portion and the cause diagnosis portion. As shown in FIG. 20, the configurations comprise a sensor-data acquisition section 1701 (corresponding to the multi-dimensional time-series signal acquisition section 103 shown in FIG. 1) for acquiring data from a plurality of sensors, learned data 1704 composed of all but normal data, a model generation section 1702 for converting the learned data into a model, an anomaly detection section 1703 for detecting the existence/non-existence of an anomaly in observed data on the basis of similarity between the observed data and the modeled learned data, a sensor-signal effect-quantity evaluation section 1705 for evaluating the quantity of an effect on sensor signals, a sensor-signal network generation section 1706 for creating a network diagram representing relevance between sensor signals, a learned-data database 1707 used for storing information such as anomaly examples, the quantity of an effect on every sensor signal and selection results, a design-information database 1708 used for storing information on designs of facilities, a cause diagnosis section 1709, a relevance database 1710 used for storing diagnosis results and an input/output section 1711. A keyword obtained as a result of execution of these kinds of processing in the configurations described above is also used in the diagnosis models explained earlier by referring to FIGS. 4A to 4E. In other words, these kinds of processing carried out in the configurations described above can also be considered as a keyword generation section.

The design-information database 1708 is also used for storing information other than the design information. In the case of an engine, for example, the information stored in the design-information database 1708 includes a model year, a model, a table of parts (BOM), past maintenance information, information on operating conditions and inspection data obtained at the transport/installation time. The past maintenance information includes an on-call description, sensor-signal data obtained in the event of a generated anomaly, an adjustment date/time, taken-image data, abnormal-noise information and information on replaced parts to mention a few.

Description of Reference Numerals
100: Anomaly prediction/diagnosis system
103: Multi-dimensional time-series signal acquisition section
120: Processor
121: Database section
122: Display section
123: Input section

1. An anomaly detection/diagnosis method for detecting an anomaly of a plant or a facility or prediction of said anomaly and for diagnosing said plant or said facility, said anomaly detection/diagnosis method including the steps of:
detecting an anomaly of said plant or said facility or prediction of said anomaly by taking sensor data acquired from a plurality of sensors installed in said plant or said facility as an object;
classifying said sensor data of said detected anomaly of said plant or said facility or said detected prediction of said anomaly by making use of maintenance-history information of said plant or said facility; and
outputting a work instruction on the basis of a result of said classification.

2. An anomaly detection/diagnosis method according to claim 1 wherein:
said maintenance-history information includes at least some of on-call data, work reports, adjustments/replaced-part codes, image information and audio information;
an appearance frequency of a keyword determined from said maintenance-history information is computed in order to obtain a pattern of said appearance frequency;
said obtained pattern of said appearance frequency is taken as a category;
said sensor data of said anomaly detected at said plant or said facility or said prediction of said anomaly is classified; and
said work instruction is output on the basis of a result of said classification.

3. An anomaly detection/diagnosis method according to claim 1 whereby:
sensor data is acquired from said sensors;
data included in said acquired sensor data as data composed of almost normal data is modeled as learned data;
said modeled learned data is used to compute an anomaly measure of said acquired sensor data as a vector; and
an anomaly of said plant or said facility is detected on the basis of the magnitude of said computed anomaly measure vector or the angle of said vector.

4. An anomaly detection/diagnosis method according to claim 1 whereby:
sensor data is acquired from said sensors;
data included in said acquired sensor data as data composed of almost normal data is modeled as learned data;
said modeled learned data is used to compute an anomaly measure of said acquired sensor data as a vector; and
an anomaly of said plant or said facility is detected on the basis of a locus generated with the lapse of time as the locus of said computed anomaly measure vector.

5. An anomaly detection/diagnosis system for detecting an anomaly of a plant or a facility or prediction of said anomaly and for diagnosing said plant or said facility, said anomaly detection/diagnosis system comprising:
an anomaly detection section for detecting an anomaly of said plant or said facility or prediction of said anomaly by taking sensor data acquired from a plurality of sensors installed in said plant or said facility as an object;
a database section for storing maintenance-history information of said plant or said facility; and
a diagnosis section for classifying said sensor data used by said anomaly detection section to detect said anomaly of said plant or said facility or said prediction of said anomaly by making use of information stored in said database section to serve as said maintenance-history information of said plant or said facility and for outputting a work instruction on the basis of a result of said classification.

6. An anomaly detection/diagnosis system according to claim 5 wherein:
said maintenance-history information stored in said database section includes at least some of on-call data, work reports, adjustments/replaced-part codes, image information and audio information; and
said diagnosis-model generation section:
computes an appearance frequency of a keyword determined from said maintenance-history information in order to obtain a pattern of said appearance frequency;
takes said obtained pattern of said appearance frequency as a category;
classifies said sensor data of said anomaly detected at said plant or said facility or said prediction of said anomaly; and
outputs said work instruction on the basis of a result of said classification.

7. An anomaly detection/diagnosis system according to claim 5 wherein:
said diagnosis-model generation section acquires sensor data from said sensors installed in said plant or said facility and models data included in said acquired sensor data as data composed of almost normal data as learned data; and
said diagnosis section makes use of said modeled learned data in order to compute an anomaly measure of said sensor data acquired from said sensors as a vector and detects an anomaly of said plant or said facility on the basis of the magnitude of said computed anomaly measure vector or the angle of said vector.

8. An anomaly detection/diagnosis system according to claim 5 wherein:
said diagnosis-model generation section acquires sensor data from said sensors installed in said plant or said facility and models data included in said acquired sensor data as data composed of almost normal data as learned data; and
said diagnosis section makes use of said modeled learned data in order to compute an anomaly measure of said acquired sensor data as a vector and detects an anomaly on the basis of a locus generated with the lapse of time as the locus of said computed anomaly measure vector.

9. An anomaly detection/diagnosis program for detecting an anomaly of a plant or a facility or prediction of said anomaly at an early time and for diagnosing said plant or said facility, said anomaly detection/diagnosis program comprising:
a processing step of detecting an anomaly of said plant or said facility or prediction of said anomaly by taking sensor data acquired from a plurality of sensors installed in said plant or said facility as an object; and
a diagnosis processing step of classifying said sensor data of said detected anomaly of said plant or said facility or said detected prediction of said anomaly by making use of maintenance-history information of said plant or said facility and outputting a work instruction on the basis of a result of said classification.

10. An anomaly detection/diagnosis program according to claim 9 wherein, at said diagnosis processing step:
a keyword is acquired from said maintenance-history information of said plant or said facility;
an appearance frequency of said acquired keyword is used in order to take a pattern of said appearance frequency as a category;
said sensor data of an anomaly of said plant or said facility or prediction of said anomaly, either of which is detected at said processing step of detecting said anomaly or said prediction of said anomaly, is classified into said categories; and
said work instruction is output on the basis of a result of said classification.

11. An enterprise/facility-asset management system comprising:
a database used for storing maintenance-history information including work reports and information on replaced parts;
detection means for detecting an anomaly or prediction of said anomaly through adoption of an identifier such as a subspace method by making use of signal information obtained from a plurality of sensors installed in a plant or a facility;
diagnosis means for diagnosing said anomaly or said prediction of said anomaly, either of which is detected by said detection means, on the basis of a frequency pattern of a keyword paying attention to part replacement or adjustment; and
work requesting means for presenting a request for a work by driving said detection means to detect an anomaly or prediction of said anomaly and by diagnosing said plant or said facility as triggered by said detection.

12. An enterprise/facility-asset management system according to claim 11, said enterprise/facility-asset management system further having phenomenon classification means for classifying an anomaly or prediction of said anomaly, either of which is detected by said detection means, into a phenomenon.

13. An enterprise/facility-asset management system according to claim 12 wherein said phenomenon classification means for classifying an anomaly or prediction of said anomaly, either of which is detected by said detection means, is capable of editing said phenomenon obtained from said classification.

14. An enterprise/facility-asset management system according to claim 11 wherein items of said frequency pattern of said keyword can be edited.

15. An enterprise/facility-asset management system according to claim 11 wherein said frequency pattern of said keyword can be displayed and edited as a context of said facility or a maintenance work.

16. An enterprise/facility-asset management system according to claim 11 wherein items of said frequency pattern of said keyword can be grouped or selected with the lapse of time.

17. An enterprise/facility-asset management system according to claim 11 wherein said keyword is a word, a symbol and a code which have been determined in said enterprise/facility-asset management system and a symbol output in processing such as said anomaly detection.

18. An enterprise/facility-asset management system according to claim 11 wherein said frequency pattern of said keyword is recorded as a pattern and, by utilizing said pattern, said maintenance-history information can be reutilized.

19. An anomaly detection/diagnosis method for detecting an anomaly of a plant or a facility or prediction of said anomaly and for diagnosing said plant or said facility, said anomaly detection/diagnosis method carried out by:
detecting an anomaly of said plant or said facility or prediction of said anomaly by taking sensor data acquired from a plurality of sensors installed in said plant or said facility as an object;
classifying said sensor data of said detected anomaly of said plant or said facility or said detected prediction of said anomaly by making use of pre-stored maintenance-history information of said plant or said facility; and
outputting branch points included in a diagnosis fault tree stored in advance to serve as points which should be verified on the basis of a result of said classification.

20. An anomaly detection/diagnosis method according to claim 19 wherein:
said maintenance-history information includes at least some of on-call data, work reports, adjustments/replaced-part codes, image information and audio information;
an appearance frequency of a keyword determined from said maintenance-history information is computed in order to obtain a pattern of said appearance frequency;
said obtained pattern of said appearance frequency is taken as a category;
said sensor data of said anomaly detected at said plant or said facility or said prediction of said anomaly is classified into the category; and
said branch points included in said diagnosis fault tree to serve as points which should be verified are output on the basis of a result of said classification.
